(19) United States
(12) Patent Application Publication
(10) Pub. No.: US 2023/0416438 A1
(43) Pub. Date: Dec. 28, 2023

(54) SINGLE ION CONDUCTING POLYMERS AND METHOD OF MAKING SAME

(71) Applicants: BLUE SOLUTIONS CANADA INC., Boucherville (CA); CAPACITOR SCIENCES INCORPORATED, Menlo Park, CA (US)

(72) Inventors: Qiujie ZHAO, Menlo Park, CA (US); Siwei LIANG, Menlo Park, CA (US); Jin YANG, Menlo Park, CA (US); Sarah DEGRAS, Brossard (CA); Patrick LEBLANC, Boucherville (CA)

(21) Appl. No.: 18/339,667

(22) Filed: Jun. 22, 2023

Related U.S. Application Data
(60) Provisional application No. 63/356,186, filed on Jun. 28, 2022.

(51) Int. Cl. C08F 263/04; C08F 261/06; C08F 279/00; C08F 255/10

(52) U.S. Cl. CPC C08F 263/04; C08F 255/10; C08F 279/00; C08F 261/06

(57) ABSTRACT

The present technology relates to a method for producing a single-ion conducting polymer comprising grafting a thiol functionalized conductor compound onto a polymer compound to obtain the single-ion conducting polymer. In certain embodiments, the thiol functionalized conductor compound can be grafted onto polymers having low Tg which result in single-ion conducting polymers having improved conductivity.

### CROSS-REFERENCE TO RELATED APPLICATION

The present patent application claims the rights and benefits to U.S. Provisional Application No. 63/356,186, filed on Jun. 28, 2022, the content of which is incorporated herein by reference.

### TECHNICAL FIELD

The present technology generally relates to single-ion conducting polymer electrolytes, and in particular to single-ion conducting polymers and methods of making same.

### BACKGROUND

A lithium battery using a lithium metal as a negative electrode has excellent energy density. However, with repeated cycles, such a battery can be subject to dendrites' growths on the surface of the lithium metal electrode when recharging the battery as the lithium ions are unevenly re-plated on the surface of the lithium metal electrode. To minimize the effect of the morphological evolution of the surface of the lithium metal anode including dendrites growth, a lithium metal battery typically uses a pressure system and a solid polymer electrolyte adapted to resist the pressure applied thereto as described in U.S. Pat. No. 6,007,935 (incorporated herein by reference). Over numerous cycles, dendrites on the surface of the lithium metal anode, however, may still grow to penetrate the solid polymer electrolyte, and eventually cause ‘soft’ short circuits between the negative electrode and the positive electrode, resulting in decreasing or poor performance of the battery. Therefore, the growth of dendrites deteriorates the cycling characteristics of the battery and constitutes a major limitation with respect to the optimization of the performance of lithium batteries having a metallic lithium anode.

Various types of solid polymer electrolytes adapted for use with lithium metal electrodes have been developed since the late 1970s to overcome this issue but have been found to lack in conductivity and/or mechanical properties. Single-ion conducting polymer electrolytes (SIPE) have, however, emerged as promising candidates, as the transference number of lithium cation approaches unity, and therefore prevents the formation of concentration gradients across the electrolyte, and dendrite formation as a result.

SIPEs are generally synthesized in two ways: (1) via synthesis of a single ion monomer, followed by the polymerization of same, or (2) by post functionalization of commercial polymers with single ion conductor groups. The later approach is more cost-effective and there are a wider range of polymer matrix to select from to synthesize SIPEs. Polymer post functionalization, however, generally requires a high efficiency reaction to ensure high conversion. Examples of such synthesis routes include synthesis of poly(ethylene oxide) methacrylate lithium sulfonyl(trifluoromethylsulfonyl)imide) (PEOMA-TF SI-Li+) monomers via a copper-catalyzed alkyne-azide “click chemistry” cycloaddition, as illustrated in FIG. 1 (Li S. et al., ACS Energy Lett. 2018, 3, 1, 20-27, incorporated herein by reference (Li S. et al)), or use of polymers comprising a thiol group such as a (Mercaptopropyl)methylsiloxane homopolymer (PDMS-SH), as illustrated in FIG. 2, to graft TFSI monomers onto the polymers (Zhao S. et al., ACS Appl. Energy Mater. 2020, 3, 12, 12540-12548, and Liang et al. Adv. Energy Mater. 2022, 2200013, both incorporated herein by reference).

“Click” reactions, such as the azide-alkyne click reaction demonstrated by Li S. et al. have generally been considered as good choices for post functionalization methods. However, such reactions involve the use of sodium azide, which is dangerous and hard to handle in scale-up productions. Moreover, the alkyne groups required for this reaction rarely exist in commercially available polymers; therefore, additional reactions steps are needed in such instances to modify the polymers and render them suitable for post functionalization.

The inventors of the present technology have also recently discovered novel methods of synthesis of LiTFSI monomers which reduce cost and have a high atom economy (i.e., produce less reactant waste), compared to existing methods, by virtue of, inter alia, comprising a single step and bypassing the synthesis of nitrogen-based organic cation intermediates. These novel synthesis routes can be applied to make SIPE with styrene, acrylate or methacrylate backbone. However, the resulting homopolymers derived from such LiTFSI monomers have high glass transition temperatures (Tg) and low conductivity at room temperature which hinder their performance as electrolytes and ultimately the performance of the battery.

Therefore, there is a need for alternative or improved methods of synthesis of SIPEs which overcome or reduce at least some of the above-described problems.

### SUMMARY

From one aspect, there is provided a method for producing a single-ion conducting polymer comprising grafting a thiol functionalized conductor compound onto a polymer compound to obtain a single-ion conducting polymer. In certain embodiments, the thiol functionalized conductor compound can be grafted onto polymers having low Tgs which result in single-ion conducting polymers having improved conductivity.

From another aspect, there is provided single-ion conducting polymer having formula A:

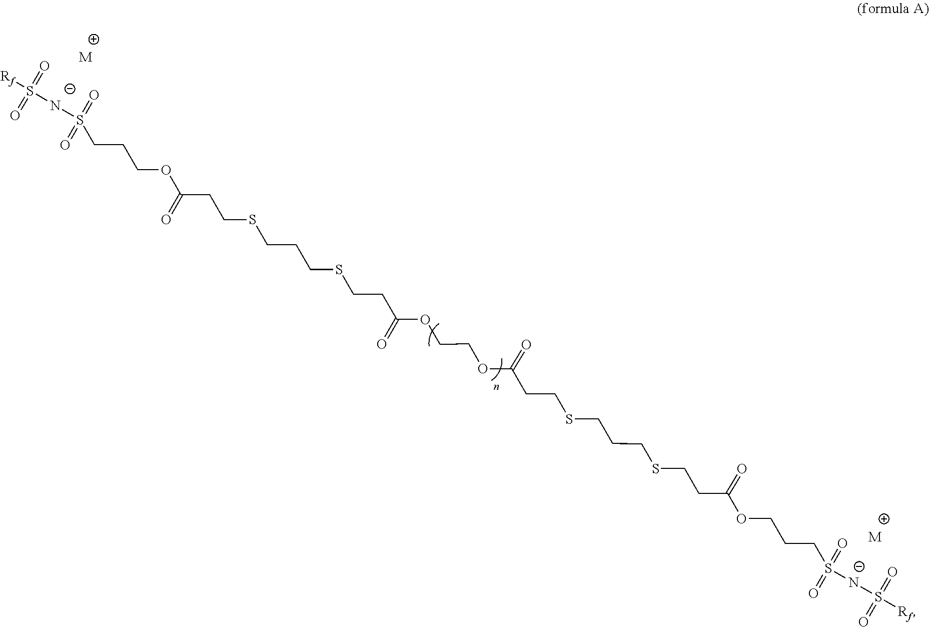

wherein R_{f} is F, CF₃, CF₂CF₃, (CH₂)ₙCF₃ wherein n is ≥1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized or an aryl substituted with at least one fluorine and at least one electron-withdrawing group; and

M⁺ is a monovalent cation.

From another aspect, there is provided a single-ion conducting polymer having formula B:

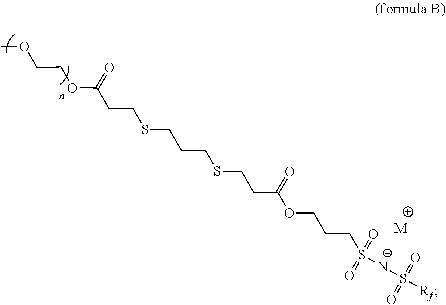

wherein R_{f} is F, CF₃, CF₂CF₃, (CH₂)ₙCF₃ wherein n is 1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group;
M⁺ is a monovalent cation; and
wherein 3≤n≤50.

From another aspect, there is provided a single-ion conducting polymer having formula C:

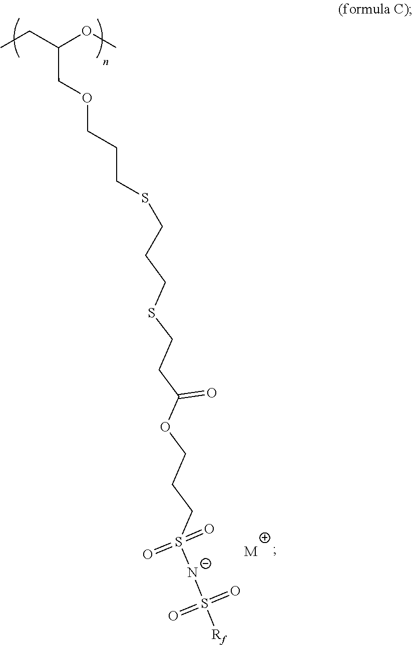

wherein R_{f} is F, CF₃, CF₂CF₃, (CH₂)ₙCF₃ wherein n is 1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group;
M⁺ is a monovalent cation; and
wherein 5≤n≤500.

From another aspect, there is provided a single-ion conducting polymer having formula D:

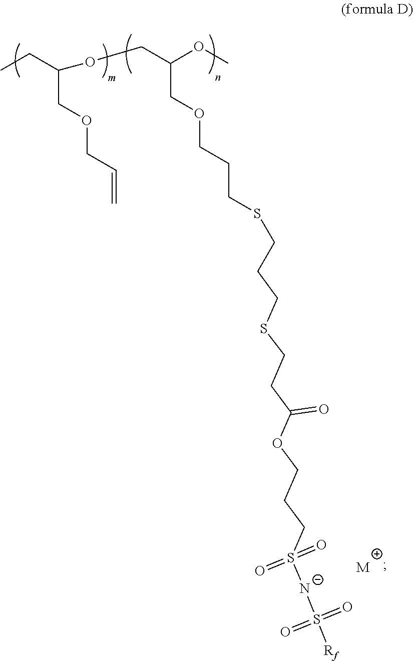

wherein R_{f} is F, CF₃, CF₂CF₃, (CH₂)ₙCF₃ wherein n is 1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group;
M⁺ is a monovalent cation;
1≤m≤500;
1≤n≤500; and
2≤m+n≤1000.

From another aspect, there is provided a single-ion conducting polymer having formula E:

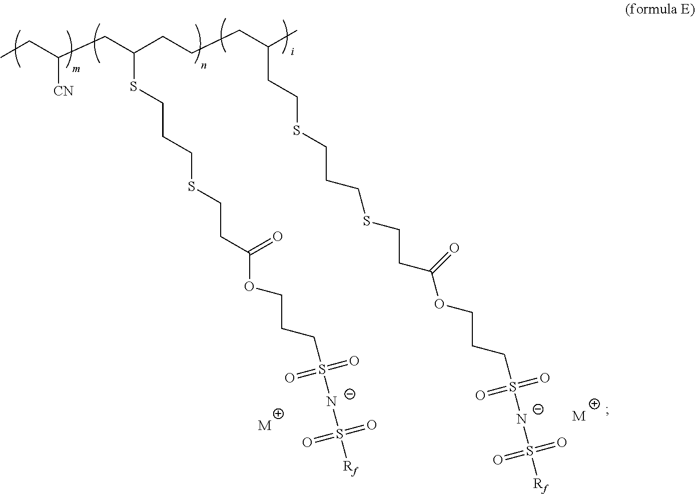

Wherein R_{f} is F, CF₃, CF₂CF₃, (CH₂)ₙCF₃ wherein n is 1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group;
M⁺ is a monovalent cation;
1≤m≤500;
1≤n≤500;
1≤l≤500, and
3≤m+n+1≤1500.

From another aspect, there is provided a single-ion conducting polymer having formula F:

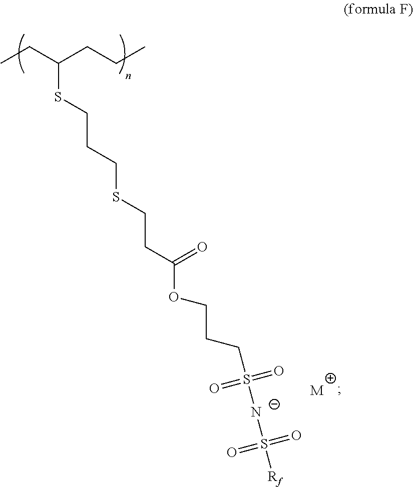

wherein R_{f} is F, CF₃, CF₂CF₃, (CH₂)ₙCF₃ wherein n is 1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group;
M⁺ is a monovalent cation; and
5≤n≤500.

From another aspect, there is provided a single-ion conducting polymer having formula G:

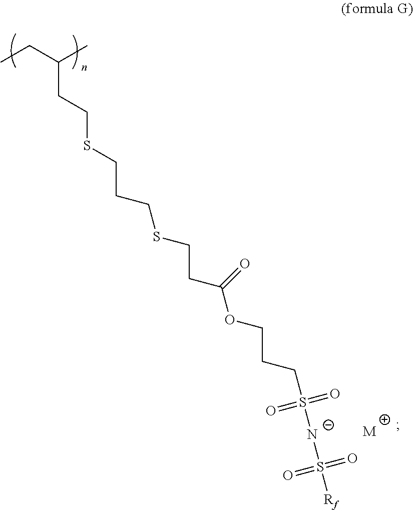

wherein R_{f} is F, CF₃, CF₂CF₃, (CH₂)ₙCF₃ wherein n is 1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group;

M⁺ is a monovalent cation; and
5≤n≤500.

From another aspect, there is provided a single-ion conducting polymer having formula H:

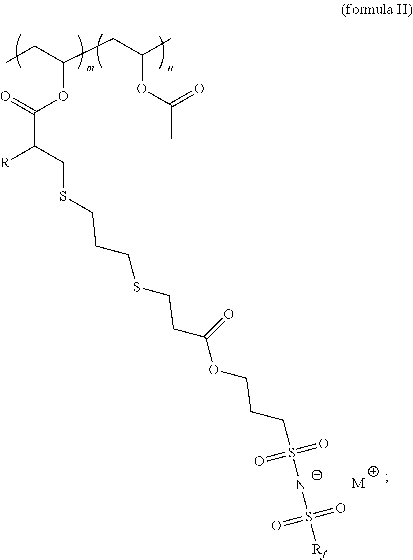

wherein R is H or CH₃;
1≤m≤6000;
n≤1500;
wherein R_{f} is F, CF₃, CF₂CF₃, (CH₂)ₙCF₃ wherein n is 1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group; and
M⁺ is a monovalent cation.

From another aspect, there is provided a single-ion conducting polymer having formula I:

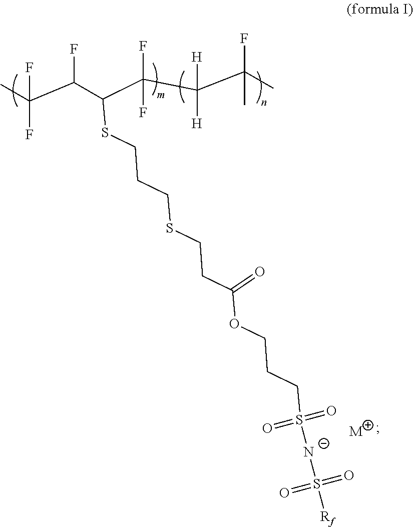

wherein R_{f} is F, CF₃, CF₂CF₃, (CH₂)ₙCF₃ wherein n is 1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group;
M⁺ is a monovalent cation;
10≤m≤3000; and
50≤n≤6000.

From another aspect, there is provided a single-ion conducting polymer having formula J:

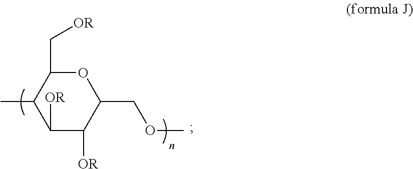

wherein R is

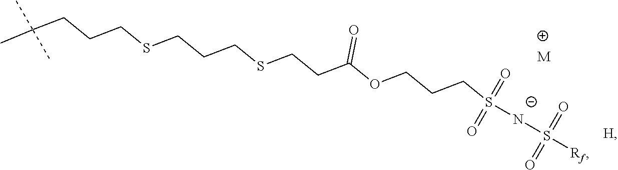

an allyl group,
or combinations thereof, and
at least one R is

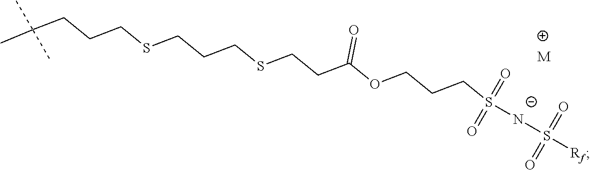

wherein R_{f} is F, CF₃, CF₂CF₃, (CH₂)ₙCF₃ wherein n is 1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group;
M⁺ is a monovalent cation; and
wherein 100≤n≤6000.

From another aspect, there is provided a single-ion conducting polymer having formula K:

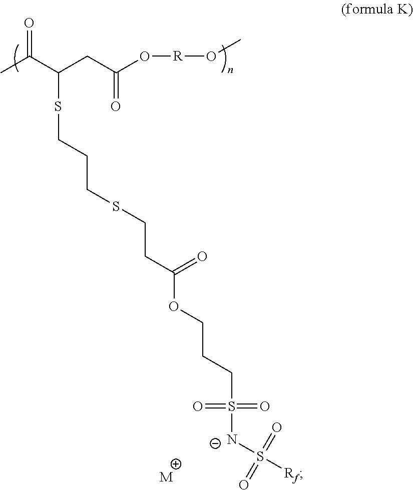

wherein R is a linear C₂-C₆ alkyl group or branched C₃-C₆ alkyl group,
R_{f} is F, CF₃, CF₂CF₃, (CH₂)ₙCF₃ wherein n is 1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group;
M⁺ is a monovalent cation; and
5≤n≤100.

From another aspect, there is provided a single-ion conducting polymer electrolyte comprising the single-ion conducting polymer of the present technology.

From another aspect, there is provided a solid-state battery comprising a positive electrode, a negative electrode and the single-ion conducting polymer electrolyte of the present technology.

From another aspect, the methods of the present technology comprise grafting the thiol functionalized conductor compound onto the polymer compound via a thiol-ene “click” reaction.

From another aspect, the methods of the present technology do not require a heating step.

From another aspect, the methods of the present technology are scalable and safe.

From another aspect, the methods of the present technology require alkene groups which are widely available in commercial polymers, or can be obtained by simple modification of commercial polymers.

### BRIEF DESCRIPTION OF THE DRAWINGS

Reference will now be made to the accompanying drawings.

FIG. 1 illustrates an existing synthesis route for poly(ethylene oxide) methacrylate lithium sulfonyl(trifluoromethylsulfonyl)imide) (PEOMA-TFSI-Li+) according to Li S. et al., ACS Energy Lett. 2018, 3, 1, 20-27 (incorporated herein by reference) using an azide-alkyne click chemistry.

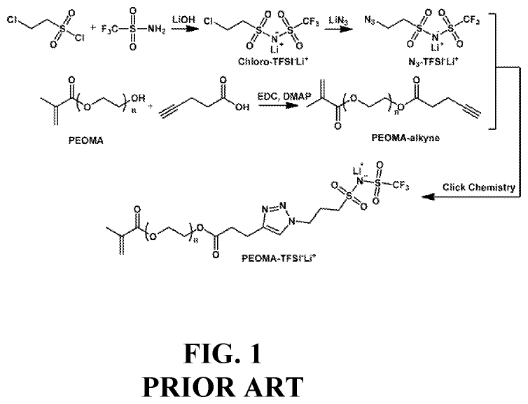

FIG. 2 illustrates an existing synthesis route for PDMS-based SIPE according to Zhao S. et al., ACS Appl. Energy Mater. 2020, 3, 12, 12540-12548 (incorporated herein by reference), using PDMS-SH as starting material.

FIG. 3 illustrates an ¹H-NMR spectra of a thiol functionalized conductor compound according to one embodiment used in the methods of the present technology (bottom panel) compared with starting materials: a LiTFSI-acrylate compound (top panel), and 1,3-propanedithiol (middle panel) used to synthesize said thiol functionalized conductor compound.

FIG. 4 illustrates an ¹H-NMR integration of the thiol functionalized conductor compound of FIG. 3 in which mono-substitution of dithiol is evident by: (1) 1:1 ratio of peak b′ vs. f1 and (2) existence of peak f2 and g′.

FIG. 5 is a schematic representation of a plurality of electrochemical cells forming a solid-state battery comprising the single-ion conducting polymer electrolytes of the present technology.

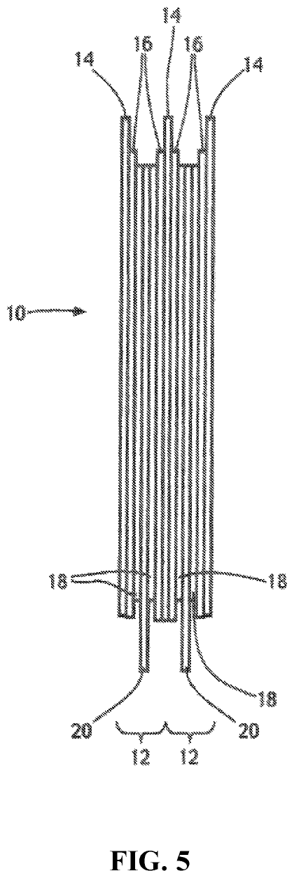

### DETAILED DESCRIPTION

### Definitions

The use of “including”, “comprising”, or “having”, “containing”, “involving” and variations thereof herein, is meant to encompass the items listed thereafter as well as, optionally, additional items.

It must be noted that, as used in this specification and the appended claims, the singular form “a”, “an” and “the” include plural referents unless the context clearly dictates otherwise.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

As used herein, the expression “single-ion conducting polymer” is a polymer comprising an immobile anion as part of its chemical structure. As used herein, the expression “immobile anion” refers to anions which are not displaced during the charge/discharge cycles of the battery.

As used herein the term “substantially” means to a great or significant extent.

As used herein, the expressions “click chemistry” or “click reaction” refers to a reaction which is simple; has a high efficiency, a high yield, and generates byproducts which are stereospecific and can be easily removed. Moreover, such reactions can be conducted in easily removable or benign solvents.

As used herein, the term “about” in the context of a given value or range refers to a value or range that is within 20%, preferably within 10%, and more preferably within 5% of the given value or range.

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting.

Broadly, the present technology relates to methods for producing a single-ion conducting polymer comprising grafting a thiol functionalized conductor compound onto a polymer compound to obtain a single-ion conducting polymer. Specifically, the thiol functionalized conductor compound is grafted onto a polymer via a thiol-ene “click” reaction. Advantageously, thiol-ene click reactions are simple and highly efficient. These reactions allow for the creation of a large variety of new polymer structures while enabling great spatial and temporal control of the materials. Moreover, in certain embodiments, the thiol functionalized conductor may be grafted onto polymers having low Tg, thus producing single-ion conducting polymers having improved conductivity.

### Thiol Functionalized Conductor Compounds

In certain embodiments, the thiol functionalized conductor compound used in the methods of the present technology comprises a covalently attached sulfonamide anion on one end, which is associated with a monovalent cation; 1-3 hydrocarbon chains as linkers (L); 0-2 functional groups (R); and a thiol group on the other end of the compound.

In some embodiments, the thiol functionalized conductor compound has formula I:

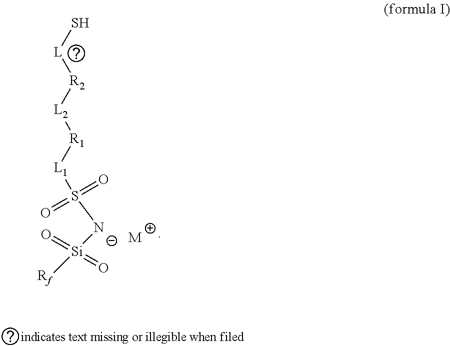

In certain embodiments, R_{f} is F, CF₃, CF₂CF₃, (CH₂)ₙCF₃ wherein n is ≥1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group. In some embodiments, the branched C₃-C₄ fluoroalkyl group comprises —CF—(CF₃)₂, —CF(CF₃)—CF₂—CF₃, and CF₂—CF—(CF₃)₂. In other embodiments, the electron withdrawing group is —CN, —NO₂, —CF₃, or —SO₂CF₃. In further embodiments, the aryl compound substituted with the at least one fluorine and the at least one electron-withdrawing group is —C₆F₄—CF₃, or —C₆F₄—SO₂CF₃. In yet further embodiments, R_{f} is CF₃.

In certain embodiments, M⁺ in the thiol functionalized conductor compound is a monovalent cation. In some embodiments, the monovalent cation is an alkali metal cation. In other embodiments, the alkali metal cation is H⁺, K⁺, Na⁺, Rb⁺, or Cs⁺. In yet other embodiments, the alkali metal cation is Li⁺.

L₁, L₂, and L₃ in the thiol functionalized conductor compound are linkers, which at least connect the sulfonamide anion on one end with the thiol group on the other end of the compound.

In certain embodiments, L₁, is an alkyl group, a fluorinated alkyl group, a branched alkyl group, an ethylene oxide linker, a fluorinated ethylene oxide linker, a cycloalkyl group, a fluorinated cycloalkyl group, a phenyl group, or a fluorinated phenyl group. In some embodiments, L₁ is a n-alkyl group and n is 1, 2, 3, 4, 5 or 6. In other embodiments, L₁ is (CH₂)₃.

L₂ may be either absent or present. When present, L₂ is a n-alkyl group, a fluorinated alkyl group, a branched alkyl group, an ethylene oxide linker, a fluorinated ethylene oxide linker, a cycloalkyl group, a fluorinated cycloalkyl group, a phenyl group, or a fluorinated phenyl group. In some embodiments, L₂ is a n-alkyl group and n is 1, 2, 3, 4, 5 or 6. In other embodiments, L₂ is (CH₂)₂.

L₃ may also be either absent or present. When present, L₃ is n-alkyl group, a fluorinated alkyl group, a branched alkyl group, an ethylene oxide linker, a fluorinated ethylene oxide linker, a cycloalkyl group, a fluorinated cycloalkyl group, a phenyl group, or a fluorinated phenyl group. In some embodiments, L₃ is a n-alkyl group and n is 2, 3, 4, 5 or 6. In other embodiments, L₃ is (CH₂)₃.

R₁ and R₂ in the thiol functionalized conductor compound are functional groups. R₂ may either be absent or present. R₁ and R₂ (when present) are each independently an ether, a thioether, an ester, an amide, a urethane, urea, a secondary amine, or a tertiary amine. In some embodiments, R₁ is an ester. In other embodiments, R₂ is a thioether.

In one embodiment, R_{f} is CF₃, M⁺ is Li⁺, L₁, L₂, and L₃ are each an n-alkyl group wherein n is 2, 3, 4, 5 or 6, R₁ is an ester, and R₂ is a thioether. In another embodiment, R_{f} is CF₃, M⁺ is Li⁺, L₁ and L₃ are (CH₂)₃, L₂ is (CH₂)₂, R₁ is an ester, and R₂ is a thioether.

In certain embodiments, the thiol functionalized conductor compound has formula II or formula III:

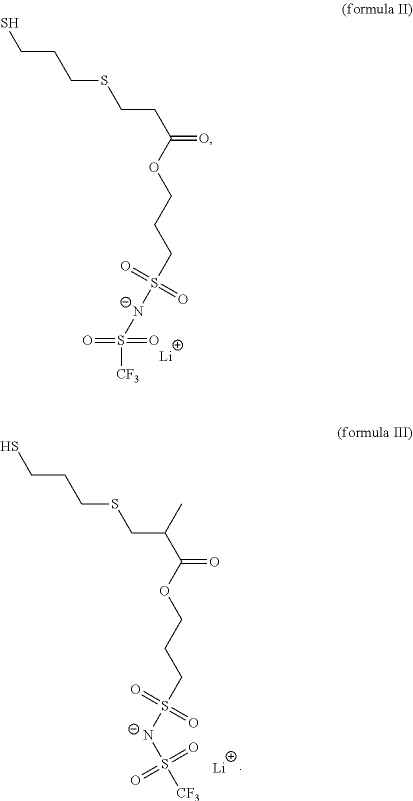 [SMILES: O=C(CCSCCCS)OCCCS(=O)(=O)[N-]S(=O)(=O)C(F)(F)F ; [Li+] ; CC(CSCCCS)C(=O)OCCCS(=O)(=O)[N-]S(=O)(=O)C(F)(F)F ; [Li+]]

In other embodiments, the thiol functionalized conductor compound has formula II.

In other embodiments, the thiol functionalized conductor compound has formula III.

In some embodiments, the thiol functionalized conductor compound is synthesized by reacting a thiol compound with a lithium bis(trifluoromethanesulfonyl)imide (LiTFSI)-monomer having a C═C in its backbone. Advantageously, this method comprises a single step, and direct addition of thiol on the LiTFSI-monomers provides an easier route of synthesis than thiol functionalized LiTFSI-monomers having the thiol directly linked to the LiTFSI via an alkyl chain.

In certain embodiments, the reaction of the thiol compound with the LiTFSI-monomer having the C═C in its backbone is also a thiol-ene “click” reaction.

In certain embodiments, the C═C in the LiTFSI-monomer is at one end of the LiTFSI-monomer. In some embodiments, the C═C is at one end of the LiTFSI-monomer and the sulfonamide anion is at the other (opposite) end of the LiTFSI-monomer. In other embodiments, the LiTFSI-monomer has the following formula IV, formula V, formula VI, formula VII, or formula VIII:

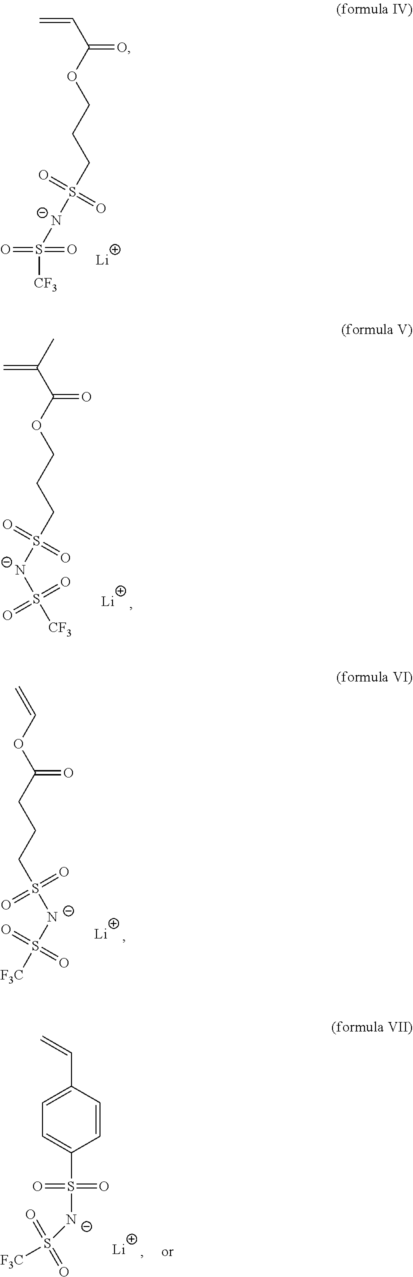

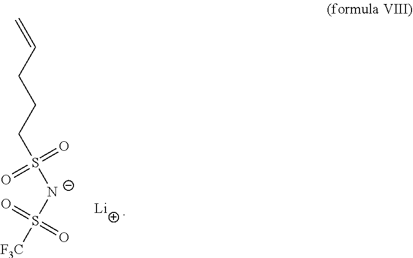 [SMILES: C=CCCCS(=O)(=O)[N-]S(=O)(=O)C(F)(F)F ; [Li+]]

In certain embodiments, the thiol compound used to synthesize the thiol functionalized conductor compound is an n-alkyl dithiol, an ethylene glycol based dithiol, a PEO-based dithiol, 2,2′-Thiodi ethanethiol, 2,3-Dimercapto-1-propanol, 1,2-benzene-dithiol, 1,3-benzene-dithiol, 1,4-benzene-dithiol, 1,4,benzenedimethanethiol, Toluene-3,4-dithiol, Biphenyl-4,4′-dithiol, p-Terphenyl-4,4-dithiol, 1,3-propane-dithiol, or 2,2′-(Ethylenedioxy)diethanethiol. In some embodiments, the n-alkyl dithiol has the formula SH—(CH₂)ₜ—SH, wherein r=2, 3, 4, 5, 6, 8, 9, 11, or 16. In other embodiments, the ethylene glycol based dithiol has the formula SH—(CH₂CH₂O)ₛ—CH₂CH₂—SH, wherein s=2, 3, or 5. In yet other embodiments, the PEO-based dithiol has the formula SH-PEO-SH, wherein the PEO has a number average molecular weight (Mn) of about 1000, about 1500, about 3400, or about 8000. In further embodiments, the thiol compound is 1,3-propane-dithiol. In yet further embodiments, the thiol compound is 2,2′-(Ethylenedioxy)diethanethiol. Advantageously, 1,3-propane-dithiol, and 2,2′-(Ethylenedioxy)diethanethiol are the cheapest dithiols available on the market which provide for an economical way of synthesizing SIPE.

In some embodiments, the thiol functionalized conductor compound is obtained by reacting an excess amount of the thiol compound with the LiTFSI-monomer. In other embodiments, the thiol functionalized conductor compound is obtained by reacting about 1 to about 4 equivalent of the thiol compound with the LiTFSI-monomer. In yet other embodiments, the method comprises reacting about 1 to about 2 equivalent, about 1 to about 3 equivalent, about 1.5 to about 2.5 equivalent, about 1 to about 1.5 equivalent, about 2 equivalent, or about 1.3 equivalent of the thiol compound with the LiTFSI-monomer.

In certain embodiments, the thiol functionalized conductor compound is obtained by reacting the thiol compound and the LiTFSI-monomer in bulk (i.e., without solvent). Such embodiments are plausible when the reactants are miscible in one another. In other embodiments, the thiol functionalized conductor compound is obtained by reacting the thiol compound and the LiTFSI-monomer in a solvent. In some embodiments, the solvent is water, methanol, ethanol, isopropanol, anhydrous methyl cyanide (MeCN), tetrahydrofuran (THF), acetone, dimethylformamide (DMF), or dimethyl sulfoxide (DMSO). In some embodiments, the thiol compound and the LiTFSI-monomer are reacted in THF.

In certain embodiments, reacting the thiol compound and the LiTFSI-monomer comprises dissolving the thiol compound and the LiTFSI-monomer together in a solvent. In other embodiments, reacting the thiol compound and the LiTFSI-monomer comprises dissolving the thiol compound in a first solvent, dissolving the LiTFSI-monomer in a second solvent and adding the dissolved LiTFSI-monomer in the second solvent to the thiol compound dissolved in the first solvent. In some embodiments, the first solvent and the second solvent are the same solvent. In other embodiments, the first solvent and the second solvent are different solvents. In such embodiments, the two different solvents are miscible in one another. The first solvent and second solvent may be any of the solvents disclosed above.

In certain embodiments, the LiTFSI-monomer dissolved in the second solvent is added to the thiol compound dissolved in the first solvent slowly and/or and in dropwise fashion. This prevents temperature jumps and solvent evaporation. The addition of the reagents, however, is not limited to a particular order. Therefore, it is understood that in other embodiments, the thiol compound dissolved in the first solvent may be added to the LiTFSI-monomer dissolved in the second solvent, for example. In certain implementations of the latter embodiments, the thiol compound dissolved in the first solvent may be added to the LiTFSI-monomer dissolved in the second solvent slowly and/or in a dropwise fashion.

In certain embodiments, the synthesis of the thiol functionalized conductor compound does not require a heating step. Specifically, in certain embodiments, the thiol functionalized conductor compound may be obtained by reacting the thiol compound and the LiTFSI-monomer at a temperature of between about 15° C. and about 30° C. In other embodiments, the thiol functionalized conductor compound is obtained by reacting the thiol compound and the LiTFSI-monomer at a temperature of about 15° C., about 20° C., about 25° C. (room temperature (RT)), or about 30° C. In yet other embodiments, the thiol functionalized conductor compound is obtained by reacting the thiol compound and the LiTFSI-monomer at a temperature of about 25° C. (RT).

In other embodiments, the thiol functionalized conductor compound is obtained by reacting the thiol compound and the LiTFSI-monomer for about 12 hours to about 24 hours. In further embodiments, the thiol functionalized conductor compound is obtained by reacting the thiol compound and the LiTFSI-monomer for about 14 hours to about 22 hours, about 16 hours to about 20 hours, or about 18 hours. In further embodiments, the thiol functionalized conductor compound is obtained by reacting the thiol compound and the LiTFSI-monomer for at least about 12 hours.

In further embodiments, the synthesis of the thiol functionalized conductor compound comprises adding a catalyst to the reaction of the thiol compound and the LiTFSI-monomer. As used herein, the term “catalyst” refers to a substance that can be added to a reaction to increase the reaction rate without getting consumed in the process. In certain embodiments, the catalyst is triethylamine (Et₃N), diethylamine, di-n-propylamine, a C₂-C₆ primary amine, N, NO, NO-tetramethyl 1,8-naphthalenediamine (proton sponge, (PS)), 1,8-diazabicyclo[5.4.0]undec-7-ene (DBU), 1,5-diazabicyclo[4.3.0]non-5-ene (DBN), tripropylphosphine, dimethylphenylphosphine diphenylmethylphosphine, or triphenylphosphine. In some embodiments, the catalyst is Et₃N. In other embodiments, the catalyst is added at an amount of between about 0.05 mol % and about 30 mol %.

In further embodiments, the synthesis of the thiol functionalized conductor compound comprises adding a free radical initiator to the reaction of the thiol compound and the LiTFSI-monomer. As used herein, the expression “free radical initiator” refers to substances that can produce free radical species under mild conditions and promote radical reactions. As used herein the expression “free radical species” refers to an uncharged molecular, typically highly reactive and short lived, having an unpaired valence electron. In the synthesis of the thiol functionalized conductor compound a free radical initiator may be used to generate a thiol free radical from the thiol compound and/or to complete the reaction between the thiol compound and the LiTFSI-monomer. In some embodiments, the free radical initiator used is a thermal activated free radical initiator. In other embodiments, the free radical initiator is a photochemically activated free radical initiator. In further embodiments, the free radical initiator is Azobisisobutyronitrile (AIBN), benzyl peroxide, 4,4′-Azobis(4-cyanovaleric acid) (ACVA), 2,2-Dimethoxy-2-phenylacetophenone (DMPA, Irgacure 651), 2-Hydroxy-2-methylpropiophenone (Irgacure 1173), or 2-Hydroxy-4′-(2-hydroxyethoxy)-2-methylpropiophenone (Irgacure 2959).

In further embodiments, the free radical initiator is added at an amount of between about 0.05 mol % and about 5 mol %, between about 0.1 mol % and about 2 mol %, or between about 0.5 mol % and about 1 mol %.

In other embodiments, the free radical initiator is photochemically activated by UV light. In some embodiments, the UV light has a wavelength of between about 250 nm and about 450 nm, between about 300 nm and about 400 nm or about 365 nm. In further embodiments, the free radical initiator is photochemically activated for a period of between about 1 minute to about 2 hours, between about 5 minutes to about 1 hour, between about 10 minutes to about 40 minutes, between about 10 minutes and about 50 minutes, between about 15 minutes and about 45 minutes, or about 30 minutes. In yet further embodiments, the free radical initiator is DMPA added at an amount of between about 0.5 mol % and about 1 mol % and irradiated with UV light for a duration of between about 10 minutes to about 40 minutes. In other embodiments, the free radical initiator is DMPA added at an amount of between about 0.5 mol % and about 1 mol %, irradiated with UV light having a wavelength of about 365 nm for a duration of about 30 minutes.

In certain embodiments, any one or more of the catalyst or the free radical initiator, or a combination thereof, may be added to the reaction of the thiol compound and the LiTFSI-monomer at the step of dissolving the thiol compound in the first solvent, dissolving the LiTFSI-monomer in the second solvent, both at the steps of dissolving the thiol compound in the first solvent and dissolving the LiTFSI-monomer in the second solvent, or at the step of dissolving the thiol compound and the LiTFSI-monomer together in a solvent. In some embodiments, the catalyst is added at the step of dissolving the thiol compound in the first solvent. In other embodiments, the free radical initiator is added at the step of dissolving the thiol compound and the LiTFSI-monomer together in a solvent.

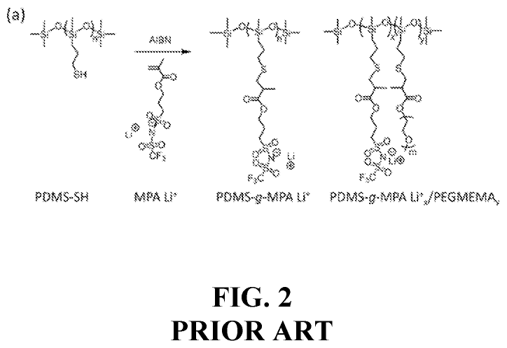

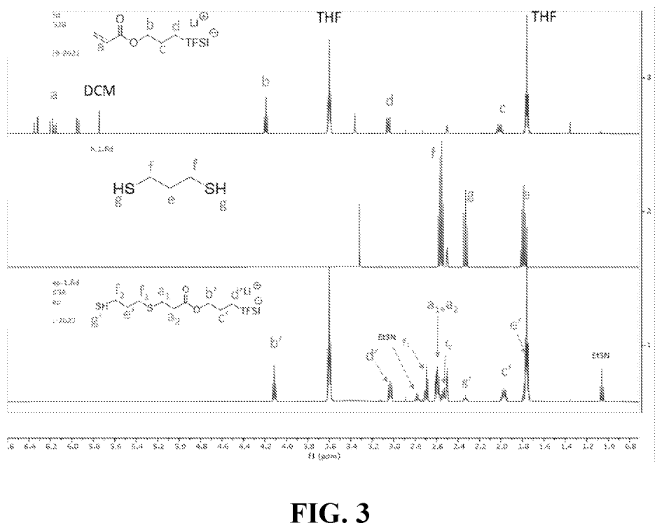

Advantageously, the methods of synthesis of the thiol functionalized conductor compound disclosed above yield a mono-substituted thiol functionalized conductor compound as their major product as confirmed by ¹H-NMR Spectra (FIGS. 2 and 3). This product may be easily purified to isolate same. Therefore, in certain embodiments, the methods of synthesis of the thiol functionalized conductor compound disclosed herewith further comprise precipitating the thiol functionalized conductor compound. In certain embodiments, precipitation of the thiol functionalized conductor compound is performed in hexane, pentane, cyclohexane, octane, or dietheyl ether. Advantageously, the thiol compound used in the synthesis of the thiol functionalized conductor compound is soluble in such solvents, thereby allowing for the excess thiol compound to be substantially removed in the precipitating step.

### Polymers

In certain embodiments, the polymer compound used in the methods of the present technology is an unmodified commercial polymer. In some embodiments, the unmodified commercial polymer is a poly(ethylene oxide) (PEO)-based polymer. Advantageously, the PEO-based single ion polymers obtained by the methods of the present technology are comparable to the classic PEO/LiTFSI salt in polymer electrolytes but with a much higher lithium transference number. In some instances, the PEO-based polymer is PEO methyl ether acrylate, PEO diacrylate, or poly(allyl glycidyl ether) (PAGE). In some embodiments, the thiol functionalized single ion conductor compound may be grafted at one end, both ends or on a side chain of the PEO-based polymer depending on the position of the C═C double bond on the polymer. In some embodiments, therefore, the thiol functionalized single ion conductor compound is grafted at one end of the PEO methyl ether acrylate. In other embodiments, the thiol functionalized single ion conductor compound is grafted at both ends of the PEO diacrylate. In yet other embodiments, the thiol functionalized single ion conductor compound is grafted on a side chain of the PAGE homopolymer. In some embodiments, PAGE can be synthesized via anionic ring opening polymerization and the C═C double bonds on the side chains can be used for thiol-ene linking of the thiol functionalized single ion conductor compound. Therefore, in certain embodiments, the PAGE polymer may comprise a thiol functionalized single ion conductor compound grafted onto each of its side chains (see, for example, formula C below). In other embodiments, the PAGE monomer may also be partially grafted such as to comprise a first side chain comprising an allyl ether group and a second side chain having the thiol functionalized single ion conductor compound grafted thereon (see, for example, formula D below).

In other embodiments, the unmodified commercial polymer used in the methods of the present technology may be a butadiene-derived polymer. Butadiene-derived polymers are one of the most common commercial polymers with applications in automobile, aviation and personal protection industries. The butadiene block has C═C double bonds available for thiol-ene reaction. In certain embodiments, the butadiene-derived polymer is poly(acrylonitrile-co-butadiene) (PAN-co-PB), poly(1,4 butadiene) or poly(1,2-butadiene). In other embodiments, the butadiene-derived polymer is poly PAN-co-PB. Advantageously, the polar acrylonitrile units of PAN-co-PB have strong dipole interactions which facilitates salt dissociation, and are suitable for use with high voltage cathode materials. In yet other embodiments, the butadiene-derived polymer is poly (1,2-butadiene).

In certain embodiments, the thiol functionalized single ion conductor compound may be grafted at any position on the butadiene-derived monomers listed above depending on the position of C═C double bonds on the molecule. Therefore, the thiol functionalized single ion conductor may be grafted on the backbone, on a side chain, or both on the backbone and a side chain of the butadiene-derived monomer. In some embodiments, the thiol functionalized single ion conductor compound is grafted on a side chain of the PAN-co-PB monomer. In some instances, one thiol functionalized single ion conductor compound is grafted on a backbone of the PAN-co-PB monomer and at least one other thiol functionalized single ion conductor compound is grafted on a side chain of the PAN-co-PB monomer.

In certain embodiments, the commercial polymer is a polyvinyl alcohol (PVA)-derived polymer. The starting polymer is a fully or partially hydrolyzed PVA and the pendant OH group can be modified to become a pendant acrylate or a pendant methacrylate group. The acrylation reaction can be done by reacting OH with acrylol chloride or methacrylol chloride. Then the thiol functionalized single ion conductor can be grafted on C═C double bonds on the side chain of PVA-derived polymer. Formula H below represents one implementation of such embodiments.

In other embodiments, the commercial polymer is a polyvinylidene difluoride (PVDF)-based polymer. PVDF is one of the most important polymers for battery applications due to its strong binding capability and its good electrochemical stability. In some embodiments, the PVDF-based polymer is a modified PVDF-based polymer. In certain implementations of these embodiments, the modified PVDF-based polymer is a modified PVDF, a modified polyvinylidene fluoride-co-chlorotrifluoroethylene (PVDF-CTFE), or a modified polyvinylidene fluoride-co-hexafluoropropylene (PVDF-HFP) monomer. In some embodiments, the PVDF-based polymers are modified by dehydrochlorination or dehydrofluorination with a base which generates C═C double bonds on the polymer backbone. Following this modification, the thiol functionalized single ion conductor compound can then react with the C═C double bond on the backbone of the modified PVDF to complete the grafting of the single ion conductor onto the polymer. Bases suitable for the modification of PVDF include, but are not limited to, inorganic bases such KOH, LiOH, and CsOH, and organic amine basic compounds such as 1,8-Diazabicyclo[5.4.0]undec-7-ene (DBU), Tetrabutylammonium hydroxide (TBAOH), Potassium t-butoxide (TBuOK), and Et3N.

In further embodiments, the polymer compound used in the method of the present technology is cellulose. Cellulose is particularly suitable as a polymer compound due to its wide availability and low price. In some embodiments, the cellulose is a modified cellulose. Specifically, the hydroxyl group on cellulose can be modified using an allyl bromide to create C═C double bonds along the cellulose backbone, and allow for the thiol functionalized single ion conductor to be grafted.

In yet further embodiments, the polymer compound is an unsaturated polyester resin (UPR). In certain implementation of these embodiments, the UPR may be made of maleic anhydride and butanediol.

### Grafting Reaction Conditions

In certain embodiments, the grafting of the thiol functionalized conductor compound onto the polymer compound comprises mixing about 1 to about 4 equivalent of the thiol functionalized conductor compound with respect to C═C mol amount on the polymer compound. In some embodiments, the grafting comprises mixing about 1 to about 3 equivalent, about 1.5 to about 2.5 equivalent, or about 2 equivalent of the thiol functionalized conductor compound with the polymer compound.

In certain embodiments, the methods of the present technology comprise mixing the thiol functionalized conductor compound and the polymer compound in bulk (i.e., without solvent). Such embodiments are plausible when the reactants are miscible in one another. In other embodiments, the methods of the present technology comprise mixing the thiol functionalized conductor compound and the polymer compound together in a solvent. In yet other embodiments, the thiol functionalized conductor compound and the polymer compound may be mixed together in bulk prior to addition into a solvent.

In some embodiments the solvent is an anhydrous solvent. In other embodiments, the solvent is an aqueous solvent. In yet other embodiments, the solvent may be a mixture of an aqueous and anhydrous solvent, wherein the aqueous solvent and the anhydrous solvent are miscible in one another. In further embodiments, the solvent is water, methanol, ethanol, isopropanol, butanol, N-Methyl-2-pyrrolidone (NMP), Dimethylacetamide (CMAc), methyl cyanide (MeCN), tetrahydrofuran (THF), acetone, dimethylformamide (DMF), or dimethyl sulfoxide (DMSO), or combinations thereof. In yet further embodiments, the solvent is THF or DMF.

In other embodiments, the methods of the present technology comprise mixing the thiol functionalized conductor compound and the PEO-based polymer in bulk and adding into THF or DMF. In yet other embodiments, the method comprises mixing the thiol functionalized conductor compound and the butadiene-derived monomer in THF or DMF. In further embodiments, the method comprises mixing the thiol functionalized conductor compound and the modified PVDF-based polymer in NMP or DMF. In yet further embodiments, the method comprises mixing the thiol functionalized conductor compound and the modified cellulose in DMAc. In other embodiments the method comprises mixing the thiol functionalized conductor compound and the modified cellulose in DMAc and LiCl.

In certain embodiments, the methods of the present technology do not require a heating step. In certain implementations of these embodiments, the grafting of the thiol functionalized conductor compound onto the polymer compound is thus performed at a temperature of between about 15° C. and about 30° C. In other embodiments, the method comprises grafting the thiol functionalized conductor compound onto the polymer compound at a temperature of between about 18° C. and about 28° C., between about 22° C. and about 27° C., or about 25° C. (i.e., room temperature (RT)). In some embodiments, the method comprises grafting the thiol functionalized conductor compound onto the polymer compound at a temperature of about 25° C. (RT).

In further embodiments, the method of the present technology comprises grafting the thiol functionalized conductor compound onto the polymer compound in the presence of a catalyst. As used herein, the term “catalyst” refers to a substance that can be added to a reaction to increase the reaction rate without getting consumed in the process. In certain embodiments, the catalyst is selected from triethylamine (Et₃N), diethylamine, di-n-propylamine, a C₂-C₆ primary amine, N,N,N′,N′-tetramethyl 1,8-naphthalenediamine (proton sponge, (PS)), 1,8-diazabicyclo[5.4.0]undec-7-ene (DBU), 1,5-diazabicyclo[4.3.0]non-5-ene (DBN), tripropylphosphine, dimethylphenylphosphine diphenylmethylphosphine, or triphenylphosphine. In other embodiments, the catalyst is added at an amount of between about 0.05 mol % and about 30 mol %.

In other embodiments, the method comprises grafting the thiol functionalized conductor compound onto the polymer compound in the presence of a free radical initiator. As used herein the expression “free radical initiator” refers to a substance that can produce free radical species and promote radical reactions. As used herein the expression “free radical species” refers to an uncharged molecule, typically highly reactive and short lived, having an unpaired valence electron. Without being bound by theory, the free radical initiator used in the methods of the present technology, once activated generates free radicals which deprotonate the thiol in the thiol functionalized conductor compound to create a thiyl radical. The thiyl radical adds onto the C═C double bond in the polymer compound and make a carbon-centered radical. This radical is then chain transferred to a new thiol and generate a new thiyl radical. The cycle continues until all thiols react with the alkenes and the reaction is complete.

In some embodiments, the free radical initiator is a thermal activated free radical initiator. In such embodiments, the method comprises a heating step. In certain implementations of these embodiments, therefore, the method comprises grafting the thiol functionalized conductor compound onto the polymer compound at a temperature of between about 40° C. and about 80° C., between about 50° C. and about 70° C., between about 60° C. and about 70° C., between about 60° C. and about 65° C., about 65° C., or about 60° C. Examples of thermal activated free radical initiators suitable for the methods of the present technology include, but are not limited to, 2,2′-Azobis(2-methylpropionitrile) (AIBN), benzyl peroxide, and 4,4′-Azobis(4-cyanovaleric acid) (ACVA). In some embodiments the thermal activated free radical initiator is AIBN.

In certain embodiments, the free radical initiator is a photochemically activated free radical initiator. Examples of photochemically activated free radical initiators suitable for the methods of the present technology include, but are not limited to, 2,2-Dimethoxy-2-phenylacetophenone (DMPA, Irgacure 651), 2-Hydroxy-2-methylpropiophenone (Irgacure 1173), or 2-Hydroxy-4′-(2-hydroxyethoxy)-2-methylpropiophenone (Irgacure 2959). In some embodiments, the photochemically activated free radical initiators is DMPA.

In certain embodiments, the free radical initiator is activated by high energy light. In other embodiments, the high energy light may be UV light. In some embodiments, the UV light has a wavelength of between about 250 nm and about 450 nm, between about 300 nm and about 400 nm or about 365 nm.

In further embodiments, the free radical initiator is photochemically activated for a period of between about 1 minute to about 2 hours, between about 5 minutes to about 1 hour, between about 10 minutes to about 40 minutes, between about 15 minutes and about 35 minutes, about 20 minutes, or about 30 minutes.

In yet further embodiments, the free radical initiator is added at an amount of between about 0.05 mol % and about 5 mol %, between about 0.1 mol % and about 2 mol %, or between about 0.5 mol % and about 1 mol %.

In certain embodiments, any one or more of the catalyst or the free radical initiator, or a combination thereof, may be added to the reaction of the thiol functionalized single-ion conductor compound and the polymer compound at the step of mixing the thiol functionalized conductor compound and the polymer compound in bulk, or mixing the thiol functionalized conductor compound and the polymer compound together in a solvent.

In certain embodiments, the grafting reaction mixture may contain an excess unreacted thiol functionalized single-ion conductor compound after the C═C bonds are all consumed and must be removed as free thiol groups will react with lithium metal. As such, in some embodiments, the methods of the present technology further comprise a purification step. In some embodiments, the purification step can be done using dialysis. The solution can be dialyzed against a polar solvent to remove the excess thiol functionalized single-ion conductor compound. In such embodiments, the dialysis solvent can be DI water, MeOH, EtOH, IPA, acetone, acetonitrile, THF or any combinations thereof. In some embodiments, the dialysis bag may be a regenerated cellulose bag. The molecular weight cutoff of said dialysis bag may be about 1 kDa, about 2 kDa, about 3.5 kDa, about 8 kDa, about 10 kDa, about 15 kDa, about 25 kDa, or about 50 kDa. In one embodiment, the dialysis bag has a molecular weight cutoff of about 3.5 kDa. Alternatively, purification can also be done via precipitation into DI water, MeOH, EtOH, IPA, acetone, acetonitrile, THF or any combination thereof to remove the excess thiol functionalized single-ion conductor compound. Alternatively, the purification can also be done via silica gel column chromatography, to remove the excess thiol functionalized single-ion conductor compound.

### Single-Ion Conducting Polymers Obtained

In certain embodiments, the single-ion conducting polymer obtained by the methods of the present technology has formula A:

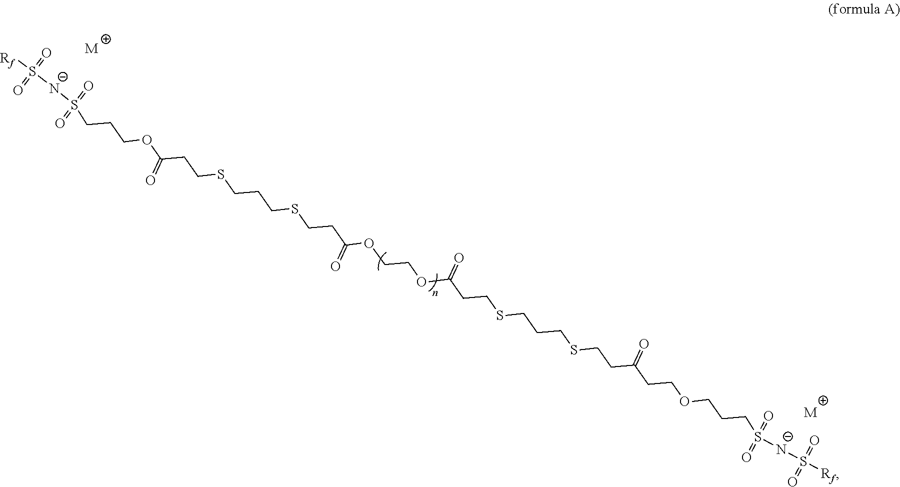

wherein R_{f} is F, CF₃, CF₂CF₃, (CH₂)ₙCF₃ wherein n is 1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group; and
M⁺ is a monovalent cation.

In other embodiments, the single-ion conducting polymer has formula B:

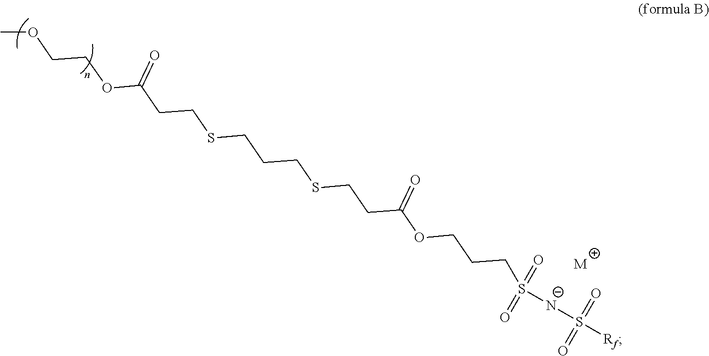

wherein R_{f} is F, CF₃, CF₂CF₃, (CH₂)ₙCF₃ wherein n is 1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group;
M⁺ is a monovalent cation; and
wherein 3≤n≤50.

In yet other embodiments, the single-ion conducting polymer has formula C:

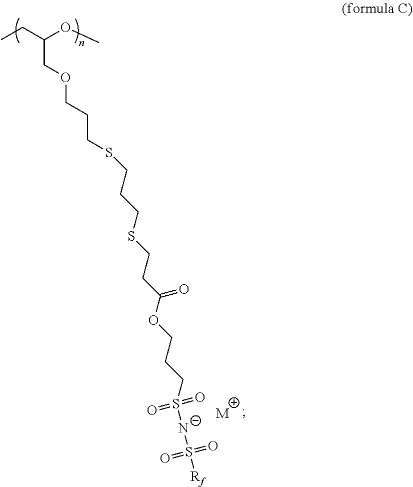

wherein R_{f} is F, CF₃, CF₂CF₃, (CH₂)ₙCF₃ wherein n is 1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group;
M⁺ is a monovalent cation; and
wherein 5≤n≤500.

In further embodiments the single-ion conducting polymer has formula D:

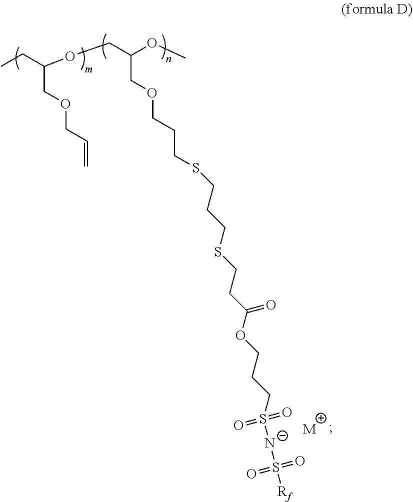

wherein R_{f} is F, CF₃, CF₂CF₃, (CH₂)ₙCF₃ wherein n is 1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group;
M⁺ is a monovalent cation;
1≤m≤500;
1≤n≤500; and
2≤m+n≤1000.

In yet further embodiments, the single-ion conducting polymer has formula E:

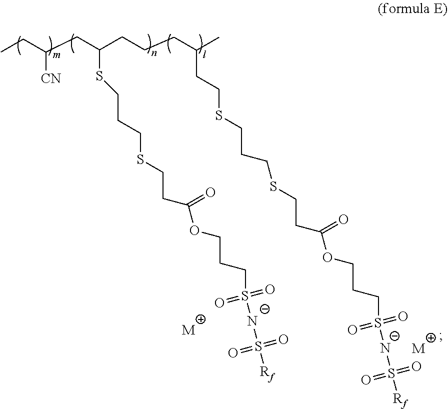

wherein R_{f} is F, CF₃, CF₂CF₃, (CH₂)ₙCF₃ wherein n is 1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group;
M⁺ is a monovalent cation;
1≤m≤500;
1≤n≤500;
1≤1≤500, and
3≤m+n+1≤1500.

In other embodiments, the single-ion conducting polymer has formula F:

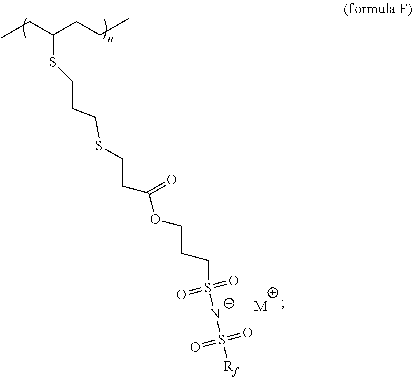

wherein R_{f} is F, CF₃, CF₂CF₃, (CH₂)ₙCF₃ wherein n is 1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group;
M⁺ is a monovalent cation; and
5≤n≤500.

In yet other embodiments, the single-ion conducting polymer has formula G:

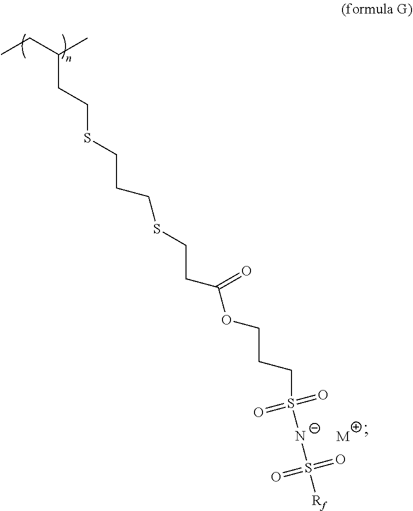

wherein R_{f} is F, CF₃, CF₂CF₃, (CH₂)ₙCF₃ wherein n is 1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group;
M⁺ is a monovalent cation; and
5≤n≤500.

In further embodiments, the single-ion conducting polymer has formula H:

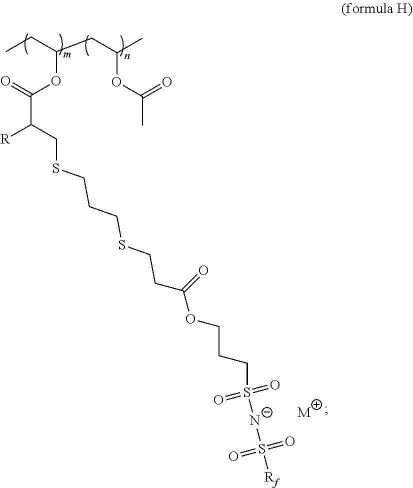

wherein R is H or CH₃;
1≤m≤6000;
0≤n≤1500;
wherein R_{f} is F, CF₃, CF₂CF₃, (CH₂)ₙCF₃ wherein n is 1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group;
M⁺ is a monovalent cation.

In yet further embodiments, the single-ion conducting polymer has formula I:

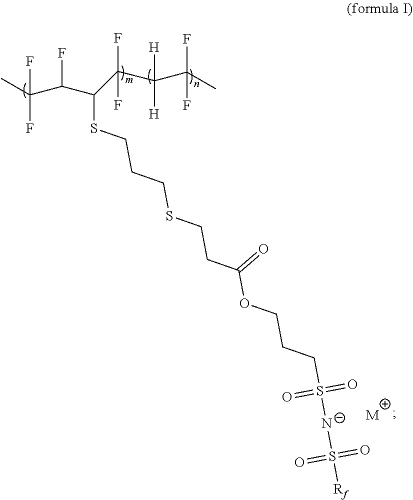

wherein R_{f} is F, CF₃, CF₂CF₃, (CH₂)ₙCF₃ wherein n is 1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group;
M⁺ is a monovalent cation;
10≤m≤3000; and
50≤n≤6000.

In some embodiments, the single-ion conducting polymer has formula J:

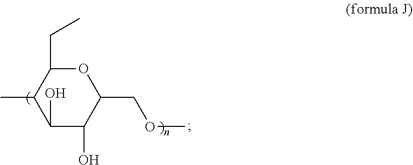

wherein R is

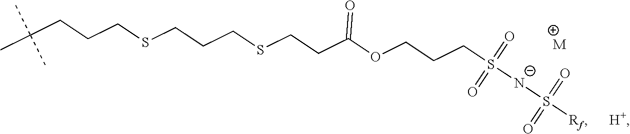

an allyl group, or combinations thereof, and
at least one R is

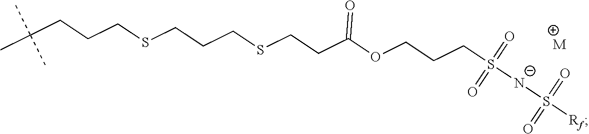

wherein R_{f} is F, CF₃, CF₂CF₃, (CH₂)ₙCF₃ wherein n is 1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group;
M⁺ is a monovalent cation; and
wherein 100≤n≤6000. In certain implementations of this embodiments, the allyl group is (—CH₂—CH═CH₂).

In other embodiments, the single-ion conducting polymer has formula K:

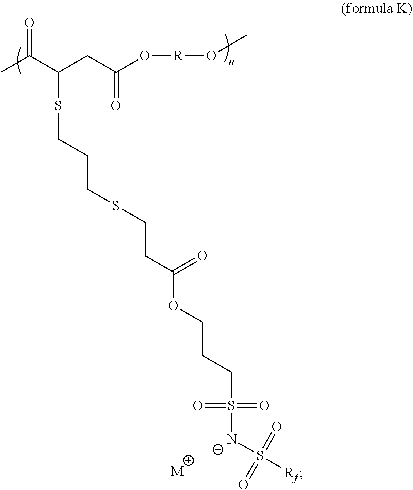

wherein R is a linear C₂-C₆ alkyl group or a branched C₃-C₆ alkyl group;
R_{f} is F, CF₃, CF₂CF₃, (CH₂)ₙCF₃ wherein n is 1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group;
M⁺ is a monovalent cation; and
5≤n≤100.

In certain embodiments of the single-ion conducting polymers disclosed above, the branched C₃-C₄ fluoroalkyl group comprises —CF—(CF₃)₂, —CF(CF₃)—CF₂—CF₃, and CF₂—CF—(CF₃)₂. In other embodiments, the electron withdrawing group is selected from —CN, —NO₂, —CF₃, and —SO₂CF₃. In further embodiments, the aryl compound substituted with the at least one fluorine and the at least one electron-withdrawing group is-C₆F₄—CF₃, or —C₆F₄—SO₂CF₃. In yet further embodiments, R_{f} is CF₃.

In certain embodiments, the monovalent cation is an alkali metal cation. In other embodiments, the alkali metal cation is H+, K+, Na+, Li+, Rb+, or Cs+. In yet other embodiments the alkali metal cation is Li+.

In further embodiments, the single-ion conducting polymer is:

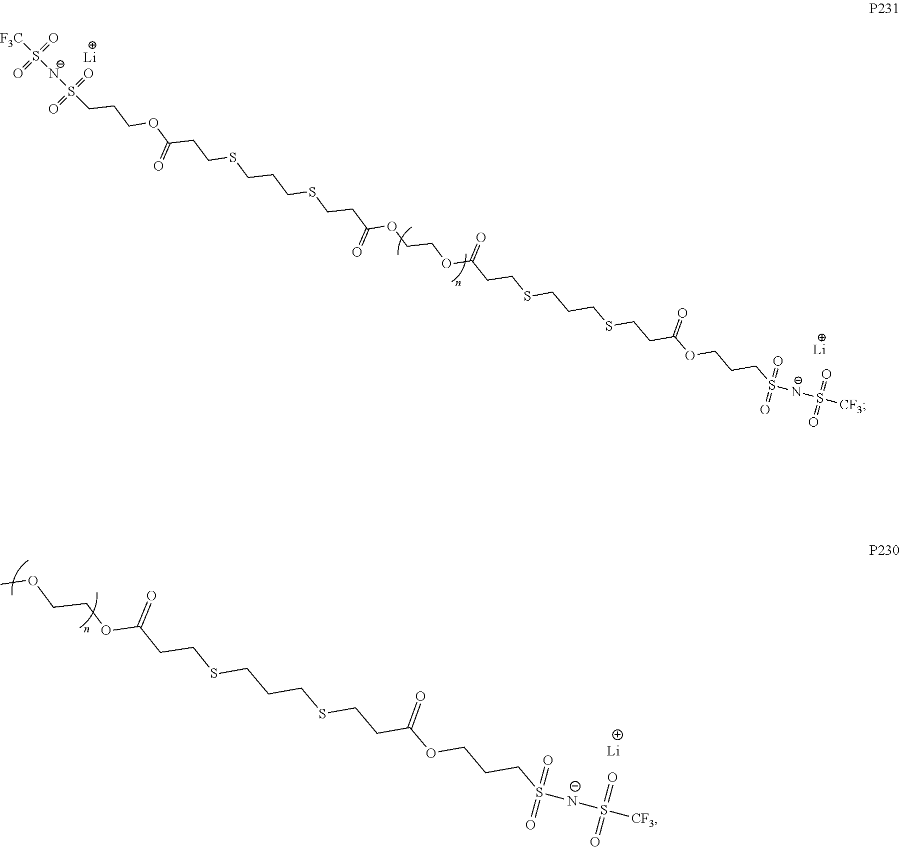

wherein 3≤n≤50;

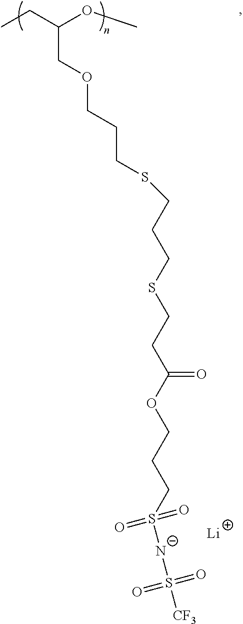

wherein 5≤n≤500;

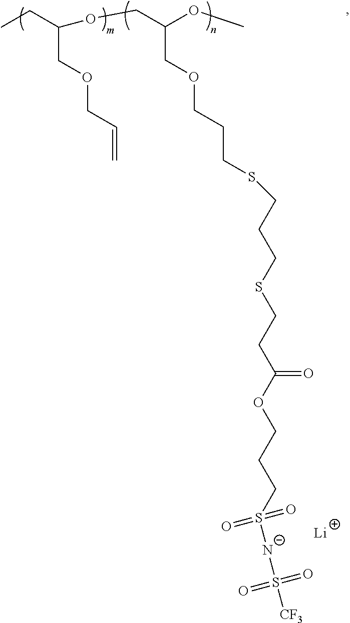

wherein 1≤m≤500, 1≤n≤500, and
2≤m+n≤1000;

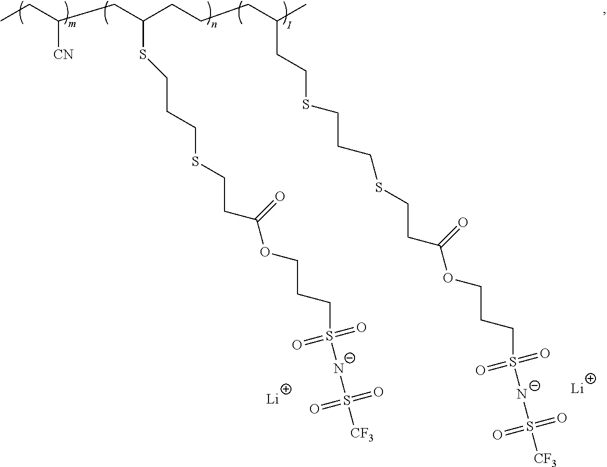

wherein 5≤n≤500;
1≤1 500, and 3≤m+n+1≤1500;

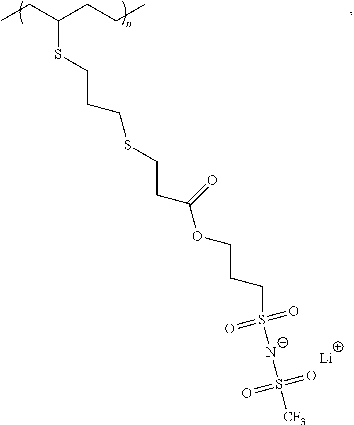

wherein 5≤n≤500;

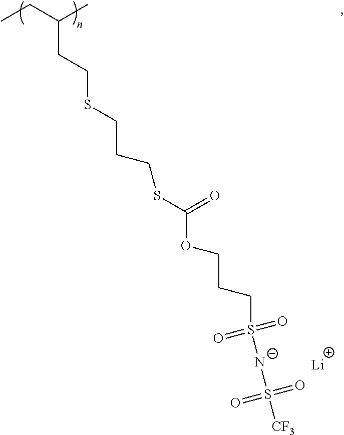

wherein 5≤n≤500;

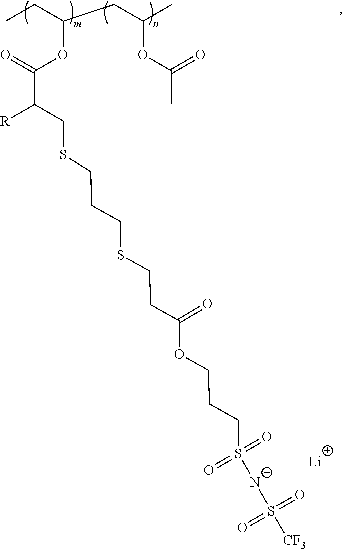

wherein R is CH₃, 1≤m≤6000, and 0≤n≤1500;

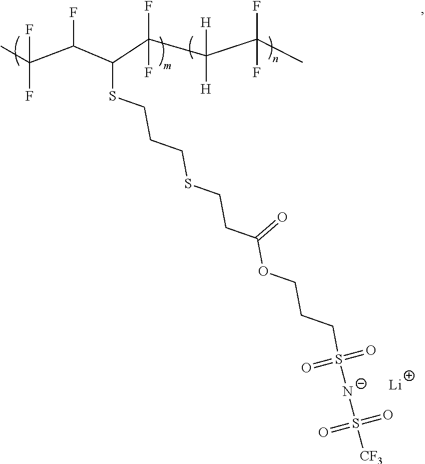

wherein 10≤m≤3000; and 50≤n≤6000;

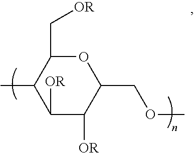

wherein R is:

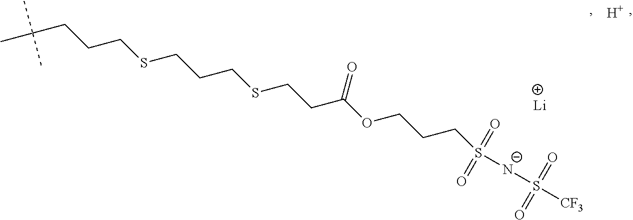

an allyl group, or combinations thereof,
at least one R is

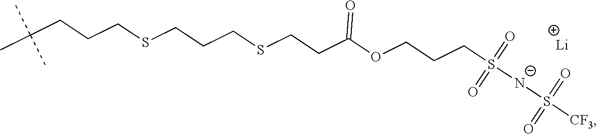

and
100≤n≤6000; or

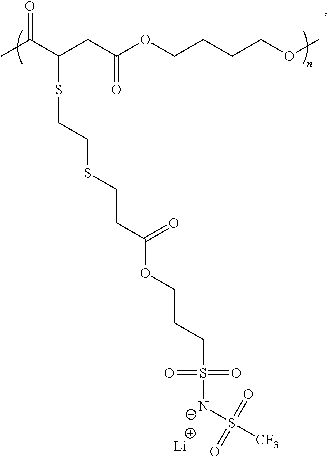

wherein 5≤n≤100.

In other embodiments, the methods of the present technology further comprise adding a lithium-containing basic compound, after the reaction has been completed, to remove any residual triethylamine in the thiol functionalized single-ion conductor compound used. In some embodiments, the addition of the lithium-containing basic compound is prior to the precipitation step described above. In other embodiments, the lithium-containing basic compound may be selected from Li₂CO₃, LiOH, LiH, Li₂SO₃, Li₃PO₄, lithium acetate, and lithium formate, and combinations thereof. In yet other embodiments, the lithium-containing basic compound is LiH.

In certain embodiments, the mass yield of the single ion conducting polymer obtained by the methods of the present technology is at least about 40%, between about 40% and about 90%, between about 45% and about 70%, between about 55% and about 70%, between about 55% and about 65%, about 46%, about 58%, about 62%, or about 85%.

### Solid-State Batteries

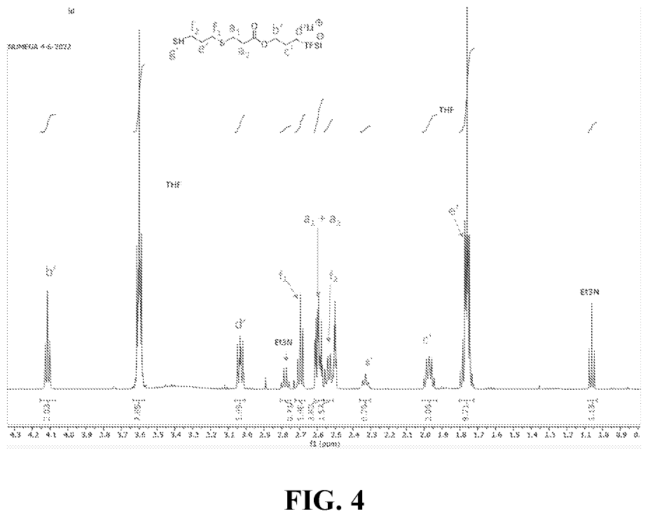

From another aspect, the present technology relates to solid-state batteries having a plurality of electrochemical cells, each electrochemical cell comprising a positive electrode, a negative electrode, and an electrolyte layer disposed therebetween. FIG. 4 schematically illustrates a solid-state battery 10 having a plurality of electrochemical cells 12 each including an anode or negative electrode film 14, a solid electrolyte 16, and a cathode or positive electrode film 18 layered onto a current collector 20. The solid electrolyte 16, typically includes a lithium salt to provide ionic conduction between the anode 14 and the cathode 18. In certain embodiments, the anode film 14 is made of a sheet of metallic lithium having a thickness ranging from about 20 microns to about 100 microns. In other embodiments, the solid electrolyte 16 has a thickness ranging from about 5 microns to about 50 microns. In further embodiments, the positive electrode film 18 has a thickness ranging from about 20 microns to about 100 microns. The single-ion conducting polymer of the present technology may be integrated in the anode film 14, the solid electrolyte 16 or the cathode film 18.

In certain embodiments, the lithium salt included in the solid electrolyte 16 may be LiCF₃SO₃, LiB (C₂O₄)₂, LiN(CF₃SO₂)₂, LiN(FSO₂)₂, LiC(CF₃SO₂)₃, LiC(CH₃)(CF₃SO₂)₂, LiCH (CF₃SO₂)₂, LiCH₂(CF₃SO₂), LiC₂F₅SO₃, LiN(C₂F₅SO₂)₂, LiN(CF₃SO₂), LiB(CF₃SO₂)₂, LiPF₆, LiSbF₆, LiClO₄, LiSCN, LiAsF₆, or LiBF₄.

The internal operating temperature of the battery 10 in the electrochemical cells 12 is typically between about 40° C. and about 100° C. Lithium polymer batteries preferably include an internal heating system to bring the electrochemical cells 12 to their optimal operating temperature. The battery 10 may be used indoors or outdoors in a wide temperature range (between about −40° C. to about +70° C.).

In certain embodiments, the lithium transference number of the single ion polymer electrolyte of the present technology is more than about 0.8, more than about 0.85, more than about 0.9, more than about 0.95, more than about 0.99, or about 1.0. In such embodiments, only the lithium cation contributes to the charge/discharge current. This allows for a uniform lithium deposition and minimizes dendrite growth, which increases the life cycle of the L₁ batteries. Such single ion conducting polymer electrolytes can act as both the lithium ion source and the matrix for polymer electrolytes, which eliminate the blending process in existing technologies where the polymer electrolytes are a mixture of PVDF, PEO and lithium salt.

### EXAMPLES

The examples below are given to illustrate the practice of various embodiments of the present disclosure. They are not intended to limit or define the entire scope of this disclosure.

### Example 1: Synthesis of a Thiol Functionalized Single-Ion Conductor Compound According to One Embodiment of the Present Technology

Briefly, 1,3,propanedithiol (2.12 g, 19.6 mmol, Sigma-Aldrich, >99%) was dissolved in 20 mL anhydrous THF (Sigma-Aldrich) in an oven-dried round bottom flask. The solution was purged with argon for ˜40 minutes (mins) and then cooled to 0° C. Triethylamine (0.45 g, 4.53 mmol, Sigma-Aldrich, >99%) was dissolved in 2 mL anhydrous THF and added to the flask. Then lithium 1-[3-(acryloyloxy)-propylsulfonyl]-1-(trifluoromethylsulfonyl)imide (J503, 5.0 g, 15.1 mmol) was dissolved in 15 mL anhydrous THF and added to the flask dropwise. The reaction was stirred and warmed up to room temperature overnight (˜18 hours (h)). After the reaction, THF was evaporated and the crude product was precipitated into 200 mL hexane four times to remove excess dithiol. The viscous liquid product was collected and dried on an rotary evaporator. ˜3.7 g clear, light yellow viscous J517 was obtained (85% yield).

The synthetic route for the preparation of the thiol functionalized single-ion conductor according to this embodiment is represented below:

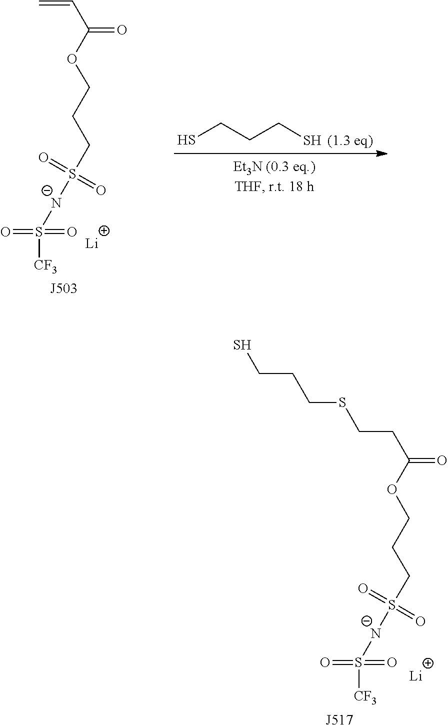

### Example 2: Synthesis of a Thiol Functionalized Single-Ion Conductor Compound According to Another Embodiment of the Present Technology

1,3-propanedithiol (0.52 g, 4.8 mmol), lithium 1-[3-(acryloyloxy)-propylsulfonyl]-1-(trifluoromethylsulfonyl)imide (J503, 0.79 g, 2.4 mmol), photoinitiator 2,2-Dimethoxy-2-phenylacetophenone (DMPA, 8 mg, 0.03 mmol, Sigma-Aldrich, 99%) were dissolved in 5 mL anhydrous THF. The solution was purged with argon for 20 mins and irradiated with 365 nm UV lamp (VWR) for 30 mins under stirring at room temperature. After the reaction, THF was evaporated and the crude product was washed with hexane four times and then vac-dried at 100° C. for ˜2 hrs. Finally, 0.85 g clear light yellow liquid was obtained (80% yield).

The synthetic route for the preparation of the thiol functionalized single-ion conductor according to this embodiment is represented below:

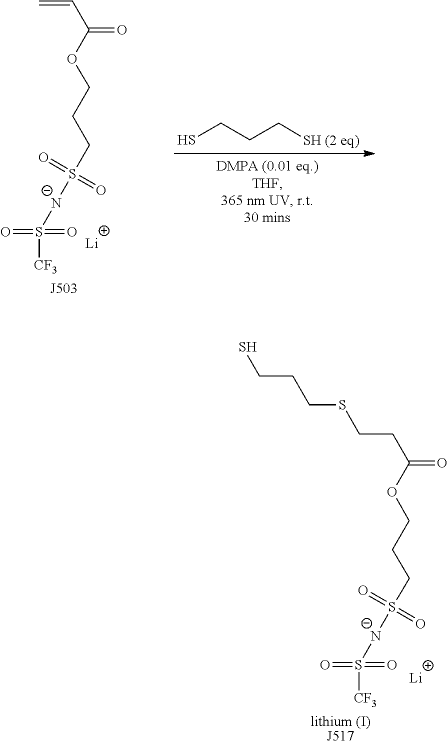

### Example 3: Grafting of a Thiol Functionalized Single-Ion Conductor Compound onto PEO-Based Polymers

A thiol functionalized single-ion conductor according to one embodiment (J517) was grafted onto PEO methyl ether acrylate, PEO diacrylate and poly(allyl glycidyl ether) (PAGE) homopolymer.

Briefly, the thiol functionalized single-ion conductor J517 (1.84 g, 4.2 mmol), Poly(ethylene glycol) methyl ether acrylate (480 g/mol, Sigma-Aldrich, 1.34 g, 2.8 mmol) and DMPA (7 mg, 0.028 mmol) were mixed and degassed with Ar. Then, 5 mL anhydrous THF was added to dissolve the mixture. The solution was irradiated with 365 nm UV (VWR UV hand lamp) for 20 mins with stirring at room temperature. After the reaction, LiH was added to remove residual triethylamine in J517. The mixture was filtered and precipitated into hexane three times to wash off Et3N. The viscous solid was vac-dried at 50 C for 24 hrs and 2.71 g product was obtained (85% yield). 1H-NMR showed no vinyl protons from the PEG-methyl ether acrylate and the final product is a mixture of P230 and J517 in 2:1 mol ratio.

The synthetic route for the grafting of the thiol functionalized single-ion conductor to PEO methyl ether acrylate is represented below:

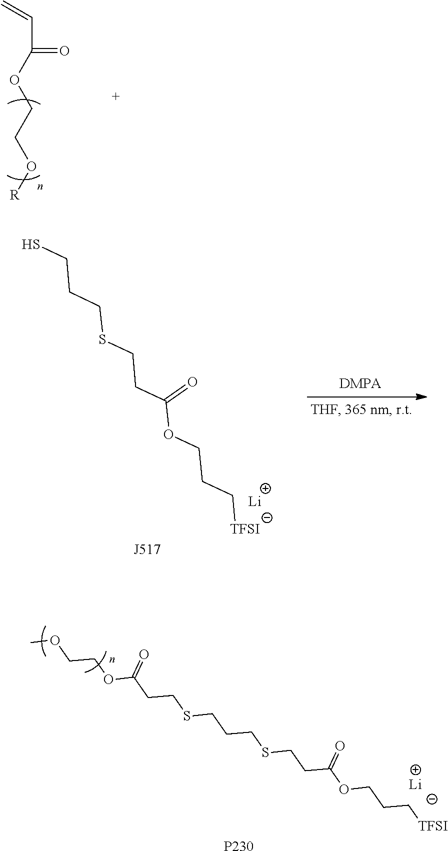

A similar synthesis was carried out with PEO diacrylate. Briefly, J517 (5.2 g, 11.8 mmol), poly(ethylene glycol) diacrylate (700 g/mol, Sigma-Aldrich, 4.1 g, 5.9 mmol) and DMPA photoinitiator (15 mg, 0.06 mmol) were dissolved in 12 mL anhydrous THF. The solution was purged with Ar for 30 mins and irradiated with 365 nm UV light (VWR UV hand lamp) for 30 mins at room temperature. ¹H-NMR showed no vinyl protons after the reaction. The product was further purified by silica gel flash chromatography (eluent profile:DCM to DCM:methanol ˜9:1 volume ratio) to remove impurities. The product P231 was collected and vacuum-dried at 60° C. for 18 hrs, which afforded 5.4 g clear, light yellow viscous liquid (58% yield).

The synthetic route for the grafting of a thiol functionalized single-ion conductor to PEO diacrylate is represented below:

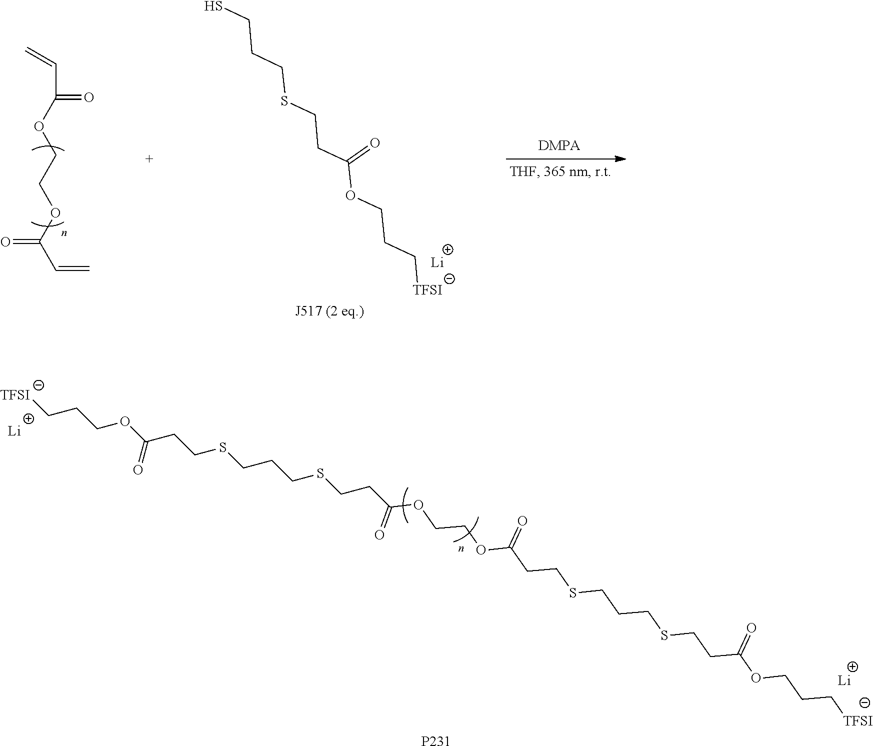

A similar synthesis was carried out with PAGE. The synthetic route for the grafting of a thiol functionalized single-ion conductor to PAGE is represented below:

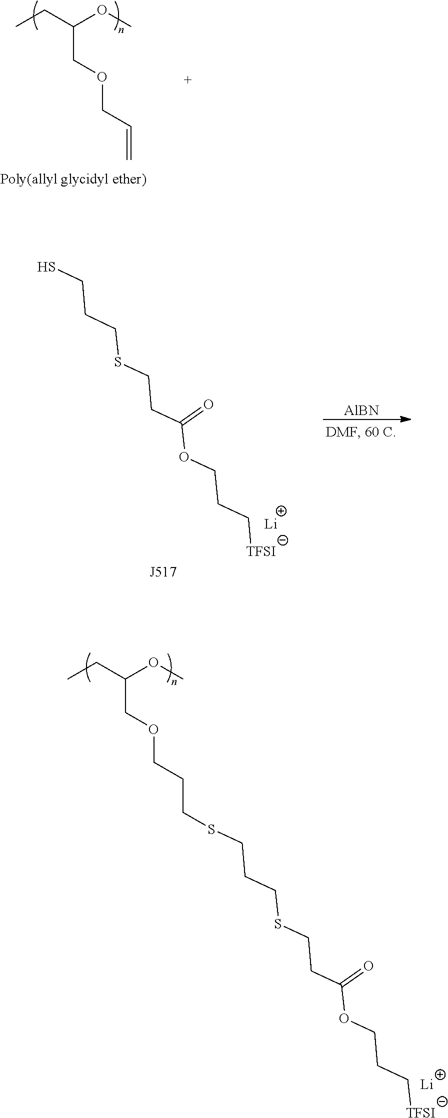

### Example 4: Grafting of a Thiol Functionalized Single-Ion Conductor Compound onto Polyacrylonitrile-Co-Butadiene) (PAN-Co-PB) and Poly(1,2-Butadiene)

A thiol functionalized single-ion conductor according to one embodiment (J517) was grafted onto PAN-co-PB. Briefly, PAN-co-PB (Sigma-Aldrich, 37-39 wt % acrylonitrile content, 0.17 g, 1.92 mmol C═C bonds), J517 (1.68 g, 3.8 mmol) and DMPA (2 mg, 0.008 mmol) were fully dissolved in 8 mL anhydrous DMF. The solution was purged with Ar for 25 mins and irradiated with 365 nm UV (VWR UV hand lamp) for 30 mins. The solution was then precipitated into ether and the bottom oily liquid was collected and further precipitated into deionized water. The white solid polymer was filtered, washed with water twice and vac-dried at r.t. for 5 hrs. ¹H NMR showed 4 mol % C═C double bonds were reacted with J517 and most of the reacted butadiene unit are 1,2-butadiene unit.

The synthetic route for the grafting of the thiol functionalized single-ion conductor to PAN-co-PB is represented below:

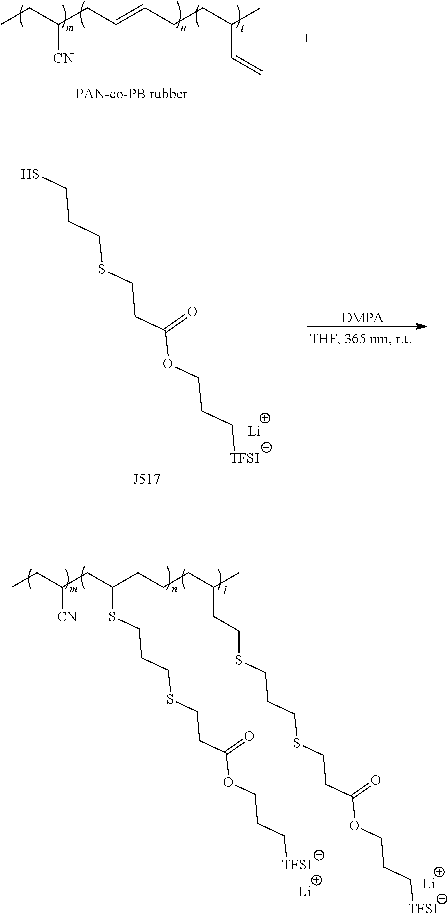

A thiol functionalized single-ion conductor according to one embodiment (J517) was grafted onto poly(1,2-butadiene) to make P243. Briefly, two poly(1,2-butadiene) with different molecular weights were used for the synthesis. In the first example, poly(1,2-butadiene) (Mn=1200 g/mol, Nisso America, 0.12 g, 2.24 mmol vinyl groups), J517 (1.19 g, 2.71 mmol) and DMPA photoinitiator (6 mg, 0.023 mmol) were fully dissolved in 3 mL anhydrous THF. The solution was purged with Ar for 20 mins and irradiated with 365 nm UV for 30 mins. After the reaction, THF was evaporated and the crude product was fully soluble in methanol, suggesting successful grafting since poly(1,2-butadiene) is not soluble in methanol. The crude product was dialyzed against pure methanol for 2 days to remove excess J517. Fresh solvent was switched twice during the 2-day period. the dialysis bag is made of regenerated cellulose and the molecular weight cutoff is 3.5 kDa (Spectra/Por 3 RC dialysis membrane). After dialysis, the polymer solution was concentrated and vacuum-dried at 80° C. for 2.5 hrs to afford 0.45 g clear, colorless viscous solid (41% yield). In the second example, a higher molecular weight poly(1,2-butadiene) (Mn=2100 g/mol, Nisso America, 0.12 g, 2.24 mmol vinyl groups), J517 (1.22 g, 2.79 mmol) and DMPA photoinitiator (6 mg, were fully dissolved in 3 mL anhydrous THF. The solution was purged with Ar for 20 mins, irradiated with 365 nm UV light for 30 mins and purified by dialysis using the same procedure described above. After vac-drying at 80° C. for 2.5 hrs, 0.69 g clear, colorless very viscous solid was obtained (62% yield).

The synthetic route for the grafting of the thiol functionalized single-ion conductor to poly(1,2-butadiene) is represented below:

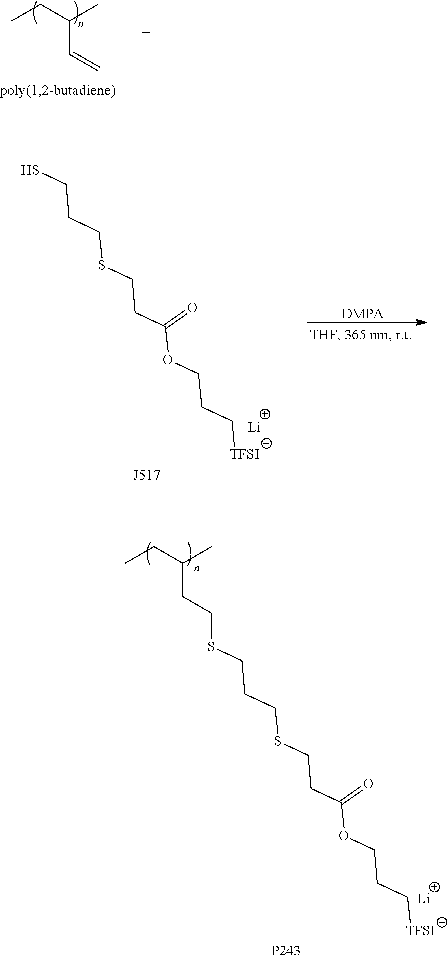

### Example 5: Grafting of a Thiol Functionalized Single-Ion Conductor Compound onto Modified PVDF

A thiol functionalized single-ion conductor according to one embodiment (J517) was grafted onto a PVDF modified via dehydrochlorination.

Briefly, a modified PVDF was made by treating PVDF-CTFE (poly vinylidene fluoride-co-chlorotrifluoroethylene 80/20 weight ratio, PolyK) with Et₃N. PVDF-CTFE (0.28 g, 0.49 mmol C₁) was fully dissolved in 5 mL NMP and Et₃N (0.25 g, 2.44 mmol) was added. The solution was stirred at 50° C. for 24 hrs and precipitated into a mixture of 3 mL 1M HCl+75 mL deionized water. The light brown solid was redissolved in acetone overnight and precipitated again into water. The solid was collected and vac-dried at 50 C for 24 hrs. FTIR showed characteristic C═C peak around 1722 cm-1 and ¹H NMR showed vinyl protons (˜6.4 ppm). NMR integration showed ˜61% C₁ was eliminated to generate C═C bonds.

The synthesis procedure of LiTFSI grafted PVDF (P242) started by dissolving P241 (1.14 g, ˜1.9 mmol C═C bonds) in 10 mL NMP with stirring overnight. The light brown polymer solution was degassed with Ar. J517 (1.0 g, 2.3 mmol) and DMPA photoinitiator (4 mg, 0.016 mmol) were dissolved in 2.5 mL NMP and added to P241 solution. The reaction mixture was further degassed with Ar and irradiated with 365 nm UV light for 30 mins. After the reaction, the solution was precipitated into 200 mL deionized water and the water was decanted. The solid was further washed with deionized water three times. The solid was vac-dried at 60° C. for 18 hrs to afford 0.92 g polymer product (46% yield).

The synthetic route for the modification of PVDF and grafting of the thiol functionalized single-ion conductor to said modified PVDF is represented below.

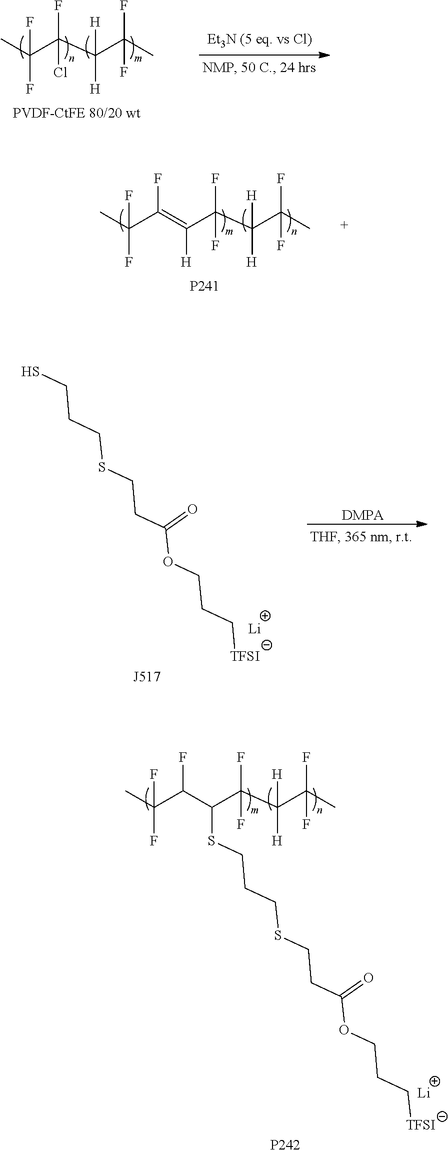

### Example 6: Grafting of a Thiol Functionalized Single-Ion Conductor Compound onto Cellulose

A thiol functionalized single-ion conductor according to one embodiment (J517) was grafted onto cellulose modified using an allyl bromide to create C═C bonds along the cellulose backbone.

The synthetic route for the modification of cellulose and grafting of the thiol functionalized single-ion conductor onto said modified cellulose is represented below:

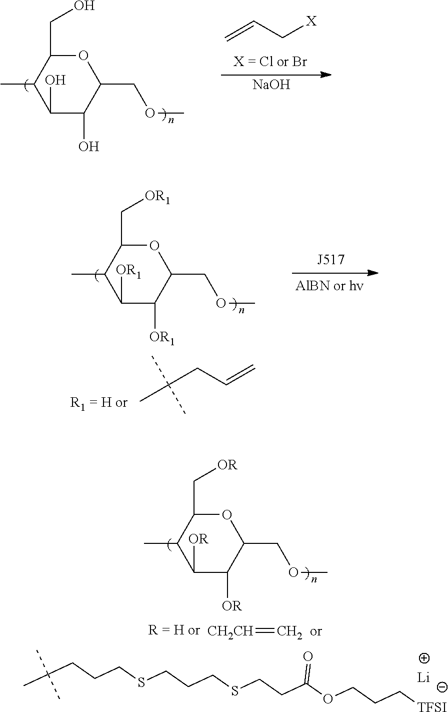

Variations and modifications will occur to those of skill in the art after reviewing this disclosure. The disclosed features may be implemented, in any combination and subcombinations (including multiple dependent combinations and subcombinations), with one or more other features described herein. The various features described or illustrated above, including any components thereof, may be combined or integrated in other systems. Moreover, certain features may be omitted or not implemented. Examples of changes, substitutions, and alterations are ascertainable by one skilled in the art and could be made without departing from the scope of the information disclosed herein.

It should be appreciated that the present technology is not limited to the particular embodiments described and illustrated herein but includes all modifications and variations falling within the scope of the present technology as defined in the appended claims.

All references cited in this specification, and their references, are incorporated by reference herein in their entirety where appropriate for teachings of additional or alternative details, features, and/or technical background.

What is claimed is:

1. A method for producing a single ion conducting polymer, the method comprising grafting a thiol functionalized conductor compound onto a polymer compound to obtain a single ion conducting polymer.

2. The method of claim 1, wherein the thiol functionalized conductor compound has formula I: 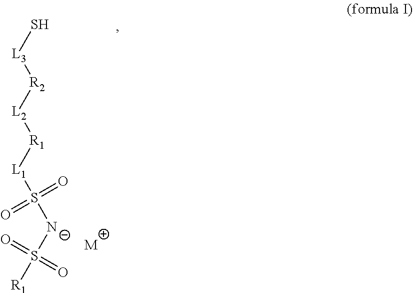
wherein:
R_{f} is F, CF₃, CF₂CF₃, (CH₂)ₙCF₃ wherein n is 1, C₆F₅, a branched C₃-C₄ fluoroalkyl group, —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine, and at least one electron-withdrawing group;
M⁺ is a monovalent cation;
L₁ is a n-alkyl group, a fluorinated alkyl group, a branched alkyl group, an ethylene oxide linker, a cycloalkyl group, a fluorinated cycloalkyl group, a phenyl group, or a fluorinated phenyl group;
L₂ is absent or present and when present is a n-alkyl group, a fluorinated alkyl group, a branched alkyl group, an ethylene oxide linker, a cycloalkyl group, a fluorinated cycloalkyl group, a phenyl group, or a fluorinated phenyl group;
L₃ is absent or present and when present is n-alkyl group, a fluorinated alkyl group, a branched alkyl group, an ethylene oxide linker, a cycloalkyl group, a fluorinated cycloalkyl group, a phenyl group, or a fluorinated phenyl group;
R₁ is an ether, a thioether, an ester, an amide, an urethane, an urea, a secondary amine, or a tertiary amine; and
R₂ is absent or present and when present is an ether, a thioether, an ester, an amide, an urethane, an urea, a secondary amine, or a tertiary amine.

3. The method of claim 2, wherein R_{f} is CF₃.

4. The method of claim 2, wherein the electron withdrawing group is —CN, —NO₂, —CF₃, or —SO₂CF₃.

5. The method of claim 2, wherein the monovalent cation is an alkali metal cation.

6. The method of claim 5, wherein the alkali metal cation is H⁺, K⁺, Na⁺, Rb⁺, or Cs⁺.

7. The method of claim 5, wherein the alkali metal cation is Li⁺.

8. The method of claim 2, wherein:
L₁ is a n-alkyl group and n is 1, 2, 3, 4, 5 or 6;
L₂ is a n-alkyl group and n is 1, 2, 3, 4, 5 or 6; and/or
L₃ is a n-alkyl group and n is 2, 3, 4, 5 or 6.

9. The method of claim 2, having formula II or formula III:

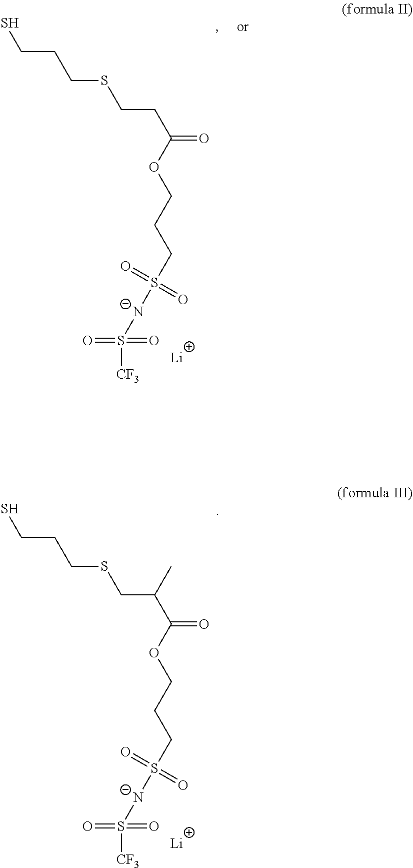 [SMILES: O=C(CCSCCCS)OCCCS(=O)(=O)[N-]S(=O)(=O)C(F)(F)F ; [Li+] ; CC(CSCCCS)C(=O)OCCCS(=O)(=O)[N-]S(=O)(=O)C(F)(F)F ; [Li+]]

10. The method of claim 1, wherein the polymer compound is a poly(ethylene oxide) (PEO)-based polymer.

11. The method of claim 10, wherein the PEO-based polymer is PEO methyl ether acrylate, PEO diacrylate, or a poly(allyl glycidyl ether) (PAGE) homopolymer.

12. The method of claim 11, wherein the thiol functionalized single ion conductor compound is grafted at one end of the PEO methyl ether acrylate or at both ends of the PEO diacrylate.

13. The method of claim 11, wherein the thiol functionalized single ion conductor compound is grafted on a side chain of the PAGE homopolymer.

14. The method of claim 1, wherein the polymer compound is a butadiene-derived polymer.

15. The method of claim 14, wherein the butadiene-derived polymer is poly(acrylonitrile-co-butadiene) (PAN-co-PB), poly(1,4 butadiene) or poly(1,2-butadiene).

16. The method of claim 15, wherein the thiol functionalized single ion conductor compound is grafted on a side chain of the PAN-co-PB.

17. The method of claim 15, wherein the butadiene-derived polymer is poly(1,2-butadiene).

18. The method of claim 1, wherein the polymer compound is an unsaturated polyester resin (UPR)

19. A single-ion conducting polymer having formula A: 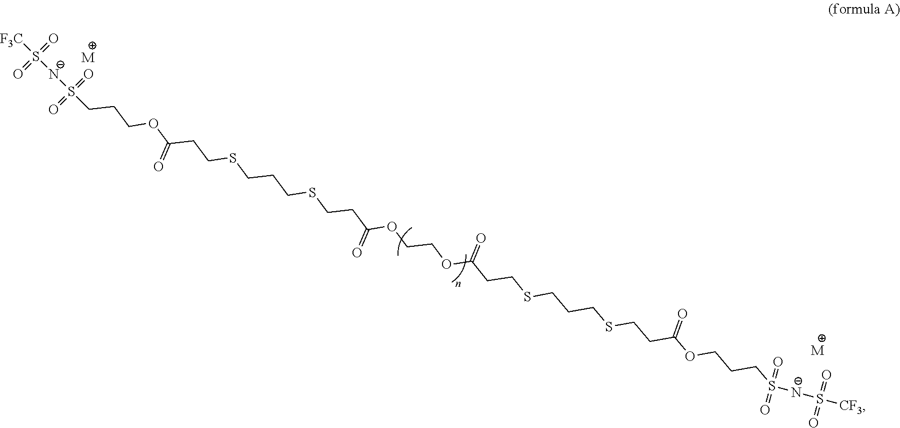
wherein R_{f} is F, CF₃, CF₂CF₃, (CH₂)ₙCF₃ wherein n is ≥1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized or an aryl substituted with at least one fluorine and at least one electron-withdrawing group; and
M⁺ is a monovalent cation.

20. A single-ion conducting polymer having formula B: 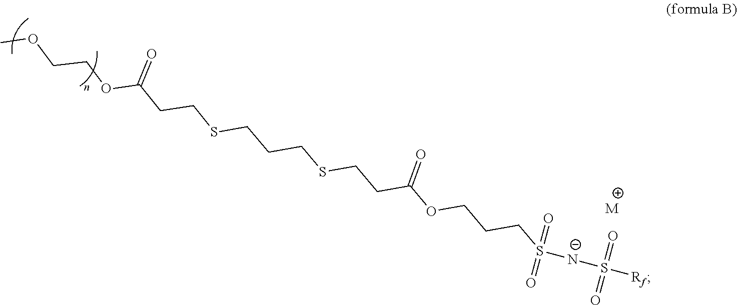
wherein R_{f} is F, CF₃, CF₂CF₃, (CH₂)ₙCF₃ wherein n is ≥1, C₆F₅, a branched C₃-C₄ fluoroalkyl group, a linear perfluorethylether group, such as —(CF₂CF₂O)ₘ—CF₂CF₃ wherein m=1, 2 or 3, —(CF₂O)ₚ/(CF₂CF₂O)_{q}—CF₂CF₃ wherein 1≤p≤10, 1≤q≤10, and the (CF₂O) and (CF₂CF₂O) units are randomly copolymerized, or an aryl substituted with at least one fluorine and at least one electron-withdrawing group;
M⁺ is a monovalent cation; and
wherein 3≤n≤50.
